(19) United States
(12) Patent Application Publication
(10) Pub. No.: US 2016/0034671 A1
(43) Pub. Date: Feb. 4, 2016

(54) Method and Apparatus for Designating Patients According to Sleep Patterns

(71) Applicant: Elwha LLC, Bellevue, WA (US)

(72) Inventors: Roderick A. Hyde, Redmond, WA (US); Jordin T. Kare, Seattle, WA (US); Elizabeth A. Sweeney, Seattle, WA (US); Sharon L. Wolda, Seattle, WA (US)

(21) Appl. No.: 14/446,065

(22) Filed: Jul. 29, 2014

(51) Int. Cl. G06F 19/00

(52) U.S. Cl. CPC G06F 19/3481; G06F 19/322

(57) ABSTRACT

A method and apparatus can include a patient profile module configured to process input data specific to at least one patient under the care of a health care facility to generate patient profile data, where a patient profile can include a sleep profile. The apparatus can further include a service delivery module configured to process input data specific to a facility or location and patient profile data to generate output data including information associated with delivery of services to patients. The apparatus can further include a resource allocation module configured to process input data specific to a facility and patient profile data to generate output data including information associated with one or more allocations of facility resources. The apparatus can further include a data controller configured to communicate output data to a user.

### BACKGROUND

The present disclosure describes a method and apparatus for managing care and service delivery and allocating resources throughout a hospital or other skilled care facility based on analysis of patients' individual sleep patterns and circadian rhythms.

### SUMMARY

The present disclosure concerns a method and apparatus for managing service delivery or resource allocation in a health care facility. The apparatus can include a patient profile module configured to process at least one element of first input data specific to at least one individual of a plurality of individuals under the care of a facility to generate a first output dataset. The first output dataset can include information associated with a patient profile. The patient profile can include at least one sleep profile associated with at least one individual. The apparatus can further include a service delivery module configured to process at least one element of second input data associated with one or more resources specific to the facility and at least one element of first output data to generate a second output dataset. The second output dataset can include information associated with a delivery of services to the at least one individual. The apparatus can further include a resource allocation module configured to process at least one element of second input data and at least one element of first output data to generate a third output dataset. The third output dataset can include information associated with the allocation of one or more resources associated with the facility. The apparatus can further include a data controller configured to communicate at least one of element of the first output dataset, the second output dataset, and the third output dataset.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic of the system described herein.

FIG. 2 is a schematic of an alternative embodiment of the system described herein.

FIG. 3 is a schematic of an alternative embodiment of the system described herein.

FIG. 4 is a schematic of an alternative embodiment of the system described herein.

FIG. 5 is a high-level flowchart of a method for designating patients according to sleep patterns.

FIGS. 6 through 62 are high-level flowcharts depicting alternate implementations of FIG. 5.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

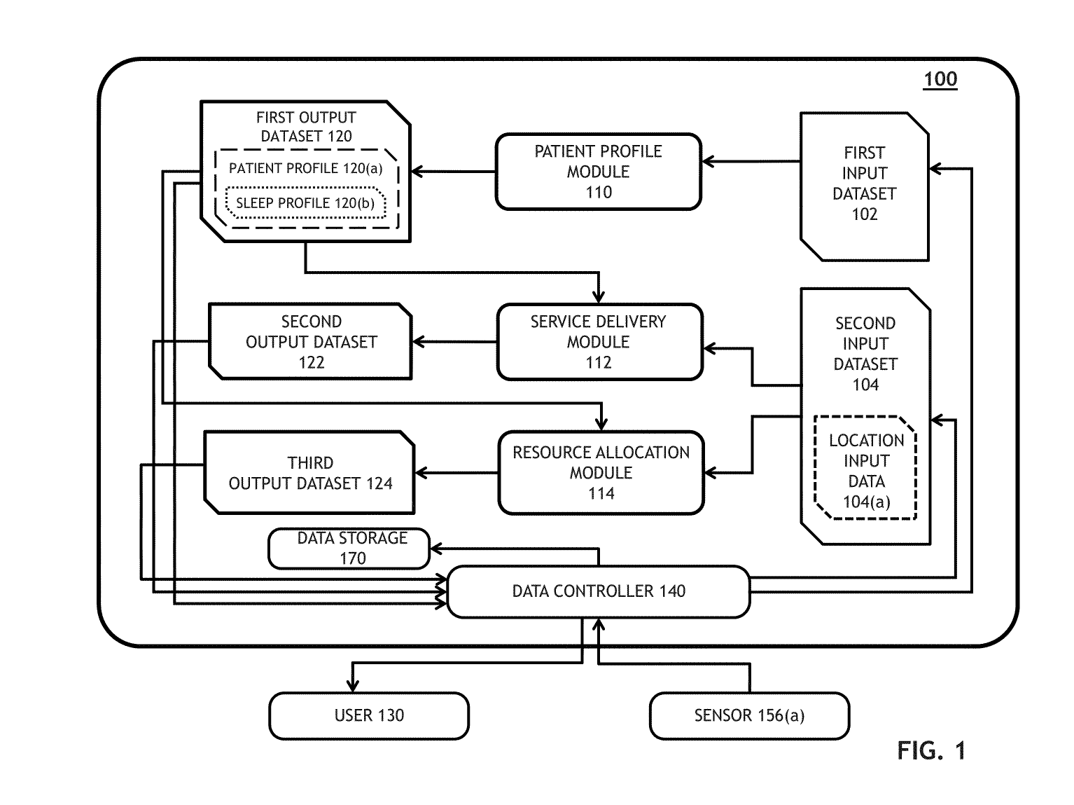

Referring now to FIG. 1, a system 100 is described in accordance with the present disclosure. The system 100 can generally include a first input dataset 102, a second input dataset 104, a patient profile module 110, a service delivery module 112, a resource allocation module 114, a first output dataset 120, a second output dataset 122, a third output dataset 124, and a data controller 140.

In an embodiment, illustrated in FIG. 1, each element of first input dataset 102 is specific to at least one of a plurality of patients. A patient refers to an individual under the care of at least one health care facility. A patient can include an individual at risk for institutional psychosis, Sundowner's Syndrome, post-discharge re-admission, or Post-hospital Syndrome (see e.g., Krumholz N Engl J Med 2013; 368:100-102 Post-Hospital Syndrome—An Acquired, Transient Condition of Generalized Risk, which is incorporated herein by reference). A patient can further include an individual suffering from at least one of a chronic illness, a mental illness, an infection and cancer. A patient can further include an individual requiring administration of at least one of chronotherapy and medication with a known chronoefficacy (see Kaur et al., Int J Clin Pharm. 2013; 35(3):344-58 Timing is important in medication administration: a timely review of chronotherapy research, which is incorporated herein by reference); for example a patient may require a circadian-dependent chemotherapy (see, e.g., Wood et al., Mol Cancer Ther 2006; 5(8):2023-33, Circadian clock coordinates cancer cell cycle progression, thymidylate synthase, and 5-fluorouracil therapeutic index, which is incorporated herein by reference). A health care facility can include, but is not limited to, at least one of a hospital, nursing facility, long-term care facility, and other institutional or residential care facility.

An element of first input dataset 102 can include at least one of a care protocol (for at least one patient a care protocol can include one or more of a clinical factor directly or not directly dependent on the treatment of at least one patient, a data element related to timing the administration of a medication prescribed to at least one patient in order to maximize the effectiveness of the medication, a patient medical history, a patient genetic profile, a patient proteomic profile, or a patient microbiome profile). A care protocol can include at least one of a treatment algorithm, a treatment requirement, or a procedure specific to at least one patient. A clinical factor can include at least one of a gender, an infectious status, an immune status, a physical or mental disability status, or a privacy preference.

In addition, first input dataset 102 includes a patient sleep profile that can include at least one data element associated with a sleep habit, a sleep cycle, a chronotype, or a circadian cycle for at least one of a plurality of patients. A sleep habit may include, but is not limited to, at least one of a charted sleep preference, a clinical observation, a sleep architecture corresponding to a given time period, or a data element derived from at least one sensor 156(a). A sleep habit may be at least a part of a care protocol input or output. A sleep cycle can include a plurality of sleep stages. A sleep stage can include at least one of stage 1 non-rapid eye movement (NREM) sleep, stage 2 NREM sleep, stage 3 NREM sleep, stage 4 NREM sleep, and REM sleep. A chronotype can include at least one of an extreme morning type (e.g., a very early rising individual), a moderate morning type, an intermediate type, a moderate evening type, and an extreme evening type (e.g., a very late rising individual).

First input dataset 102 can include medical record data and newly acquired data from sensor 156(a). Sensor 156(a) can include, but is not limited to, a full polysomnographic array or at least one electroencephalographic, electrooculographic, electrocardiographic, or electromyelographic channel thereof. First input dataset 102 can additionally include data acquired from electronic medical records or a database, or from responses to a questionnaire.

Each element of a plurality of elements of second input dataset 104 is specific to a health care facility. Second input dataset 104 further includes dataset 104(a). Each element of a plurality of elements of dataset 104(a) is specific to at least one location within a health care facility. A location can include a bed, room, portion of a room, ward, floor level, subdivision, or other accommodation within a health care facility. An element of dataset 104(a) can include a sensory factor specific to at least one location, a census of patients assigned to at least one location, or a ratio representing a proportion of patients to staff members assigned to at least one location. Sensory factors are those aspects of the hospital environment that may be exploited for therapeutic benefit including, but not limited to, ambient sound profiles, the presence of windows or other natural lighting, or available sources of artificial lighting of various types. A sensory factor can further include, but is not limited to, at least one of a light level, a noise level, a traffic level (or level of disruption and the like), an air pressure level, a humidity level, a temperature level, and an atmospheric condition level.

System 100 includes a patient profile module 110 configured to (i.e., includes at least one of software, circuitry or a processor programmed to) analyze at least one element of first input dataset 102, and process the at least one element to generate at least one element of first output dataset 120. Each of a plurality of dataset elements of first output dataset 120 can include a patient profile 120(a) uniquely associated with at least one of a plurality of patients. A patient profile 120(a) may include, but is not limited to, a sleep profile 120(b). A sleep profile 120(b) may include, but is not limited to, predictive data related to chronotype: when a patient is most likely to wake up each morning; when the patient is likely to be at his/her most or least alert throughout the day, and thus what times would be recommended or contraindicated for medical treatments or procedures; suggested times for the maximally efficient administration of medications; what time the patient is likely to retire to bed each evening; the duration and quality of sleep likely to result; and observed sleep architecture throughout a sleep session. A patient profile 120(a) may additionally include predictive, assigned, or compiled data elements.

A sleep profile 120(b) can include, but is not limited to, at least one data element related to a sleep habit, a sleep cycle, a chronotype, or a circadian cycle for at least one of a plurality of patients. A sleep cycle can include a plurality of sleep stages. A sleep stage can include at least one of stage 1 non-rapid eye movement (NREM) sleep, stage 2 NREM sleep, stage 3 NREM sleep, stage 4 NREM sleep, or rapid eye movement (REM) sleep. A chronotype can include at least one of an extreme morning type, a moderate morning type, an intermediate type, a moderate evening type, and an extreme evening type. Patient profile module 110 may categorize or define predicted patient chronotypes with greater or lesser precision depending on the needs or objectives of a given hospital or facility.

System 100 further includes a service delivery module 112. Service delivery module 112 is configured to (i.e., includes at least one of software, circuitry or a processor programmed to) process at least one element of second input dataset 104 and to process at least one element of first output dataset 120 to generate at least one element of second output dataset 122. Each of a plurality of elements of second output dataset 122 can represent information associated with a delivery of services to at least one of a plurality of patients.

Service delivery module 112 can be further configured to, for example, using at least one of software, circuitry or hardware such as a processor, assign at least one of a plurality of patients to at least one healthcare facility location based on at least one of an element of first output dataset 120 and an element of second input dataset 104. Service delivery module 112 can be configured to assign at least one delivery of services to at least one patient of a plurality of patients based on at least one of an element of first output dataset 120 and an element of second input dataset 104. A delivery of services can include, but is not limited to, at least one of a required treatment, medication administration, therapy session, maintenance procedure, or clinical procedure performed for the benefit of at least one patient. Service delivery module 112 can be configured to generate at least one schedule specific to at least one of a healthcare facility location or a plurality of patients assigned to a location, based on at least one of an element of first output dataset 120 and an element of second input dataset 104. Service delivery module 112 can be configured to assign at least one of a plurality of patients to at least one location so as to reduce sleep cycle disruption for at least one patient assigned to the at least one location. For example, if a plurality of patients displaying characteristics of early-rising or morning chronotypes are assigned to a particular location, staff members can be directed to interact with those patients earlier in the morning for medical treatments, clinical procedures, meal delivery, medication administrations, etc., finding the patients generally alert, well rested, and receptive when doing so. Similarly, staff members can be directed to avoid interaction with these patients after the mid- to late evening hours wherever possible, so as not to disturb the patients' sleep. A schedule can include, but is not limited to, at least one delivery of services to of at least one patient. Service delivery module 112 can be configured to revise a schedule by adding a delivery of services or deleting a delivery of services based on revised information associated with a patient profile or information acquired through monitoring a sleep pattern of at least one patient. Service delivery module 112 can be configured to provide information, generate a recommendation, or issue a decision associated with the delivery of services to at least one patient.

A delivery of services can include the manipulation of at least one sensory factor specific to at least one healthcare facility location in order to constructively modulate the sleep cycle of at least one of a plurality of patients. For example, the sleep patterns of a particular patient may be so pronounced as to interfere with optimal hospital scheduling; the patient may normally rise at such an early hour, and retire so early in the day, that staff members cannot easily accommodate the patient without creating disruptions for other nearby patients or staff members. For example, the sleep patterns of a patient may be incompatible with a medication regiment or less beneficial to a health outcome. It may therefore be desirable to constructively modulate the patient's sleep habits or patterns so that they become less extreme, perhaps by photic entrainment through timely application of high-intensity light, advancing or delaying the sleep-wake cycle. Service delivery module 112 may assign the patient to a particular room or ward and recommend specific lighting adjustments there for the patient's benefit. Inherent sensory factors may render the room especially useful for phase-advancing light therapy in that the room be equipped with east-facing windows in order to provide intense natural lighting during the morning hours. In the alternative, the room may be equipped with light boxes or other such devices that deliver therapeutic amounts of artificial light in the appropriate wavelengths in order to constructively modulate the patient's sleep cycles so that they reflect a less extreme early-rising chronotype.

System 100 can include a resource allocation module 114, configured to (i.e., includes at least one of software, circuitry or a processor programmed to) process at least one of an element of second input dataset 104 and an element of first output dataset 120 to generate at least one element of third output dataset 124. Each of a plurality of elements of third output dataset 124 can include information associated with the allocation of one or more resources associated with a health care facility. A resource can include, but is not limited to, at least one of a staff member, at least one item of facility equipment or service, and at least one facility accommodation. Resource allocation module 114 can be configured (for example, using at least one of software, circuitry or a processor) to allocate a responsibility of care for at least one patient to at least one staff member, based on at least one element of third output dataset 124. An allocation of responsibility can include, but is not limited to, assigning at least one staff member to at least one location within the facility, based on at least one element of third output dataset 124. An allocation of responsibility can be chosen to reduce sleep cycle disruption for said at least one individual. An allocation of responsibility for the care of at least one individual can be chosen so that the at least one individual represents either a uniform distribution or a staggered distribution of associated sleep profiles. For example, resource allocation module 114 may prioritize efficient patient-staff interactions by staggering the schedule of assigned tasks for a given staff member such that the staff member can regularly interact with patients of progressively later chronotype as the day progresses. Patients will likely be at their most alert, awake, and receptive for such interactions, and more efficient and productive use can be made of the staff member's time. Resource allocation module 114 can be configured to provide information associated with an allocation of responsibility, provide a recommendation associated with an allocation of responsibility, or issue a decision associated with an allocation of responsibility.

Resource allocation module 114 can be configured to generate a schedule of at least one allocation of responsibility to a staff member, based on at least one of an element of first output dataset 120 and an element of second input dataset 104. A staff member can include, but is not limited to, at least one of a physician, nurse, nurse aide, therapist, or service provider associated with a health care facility. A service provider can include clinical staff and maintenance staff (e.g., cleaning staff). A facility accommodation can include, but is not limited to, a room, a portion of a room, or a bed within the facility. An allocation of responsibility can include, but is not limited to, at least one facilities maintenance task, such as janitorial, lighting, electrical, and any other operation which may be disruptive. Additionally, the system may determine the likely magnitude of a disruption or potential disruption in the context of a care protocol or need (facility, patient, other patient, or staff). Resource allocation module 114 can be configured to revise at least one previously generated schedule, for example, based on at least one of revised information associated with a first output dataset 120 or information acquired by monitoring the sleep of at least one patient. Resource allocation module 114 can be configured to revise a schedule, for example, by adding an allocation of responsibility or deleting an allocation of responsibility.

System 100 can include a data controller 140 configured to communicate at least one element of first output dataset 120, second output dataset 122, and third output dataset 124 to a user 130. Data controller 140 can be configured to process at least one of an element of first output dataset 120, second output dataset 122, and third output dataset 124 prior to communication. Processing can include, but is not limited to, analyzing the at least one element, manipulating the at least one element, or storing the at least one element in data storage medium 170.

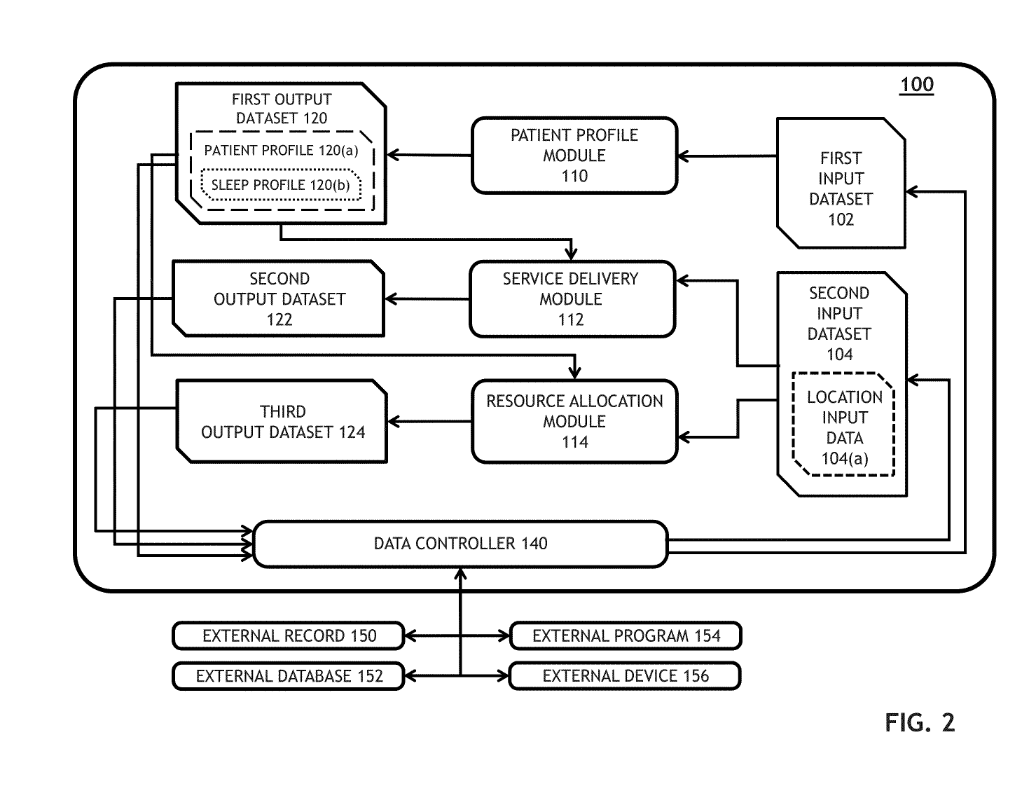

In an embodiment, illustrated in FIG. 2, data controller 140 is configured to (i.e., includes one of software, circuitry or a processor programmed to) communicate with at least one of an external record 150, an external database 152, an external program 154, and an external device 156. Each of external record 150, external database 152, external program 154, or external device 156 can include, but is not limited to, at least one of hospital management software, facility management software, bed management software, patient flow software, staff scheduling software, or electronic medical records. Electronic medical records can include orders tracking, including tracking of orders from physicians or other health care providers. Data controller 140 can be configured to collect at least one of an element of input data from at least one of external record 150, external database 152, external program 154, or external device 156.

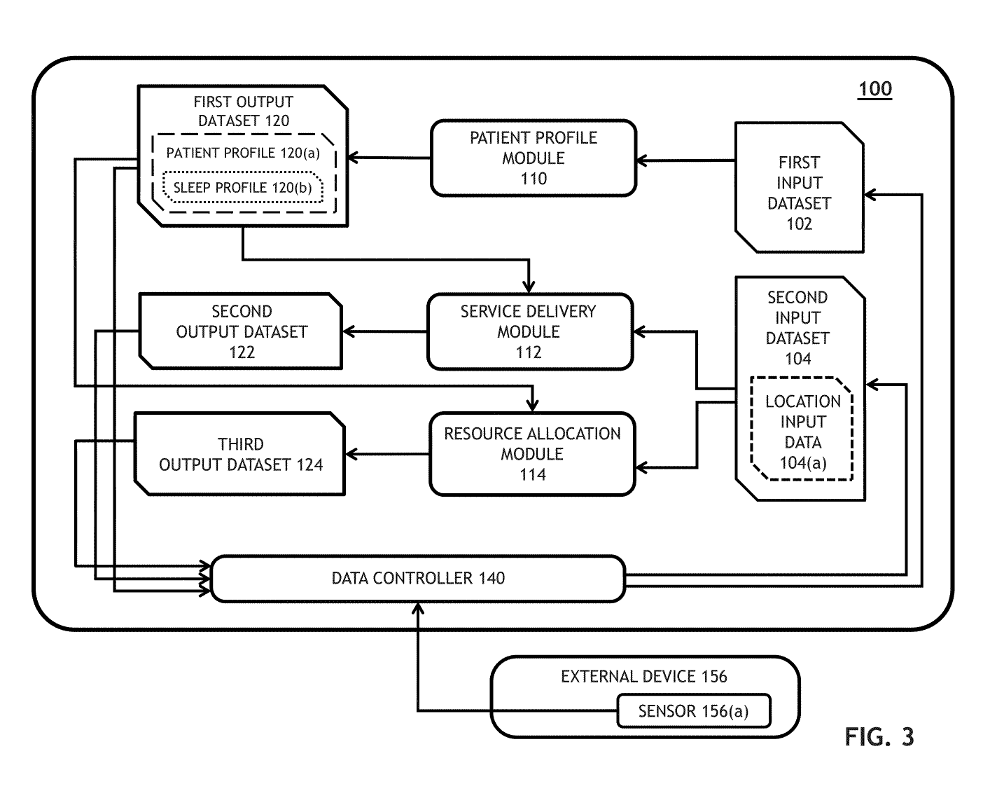

In an embodiment, illustrated in FIG. 3, external device 156 includes at least one sensor 156(a) configured to monitor a sleep pattern of the at least one of a plurality of patients. Sensor 156(a) can include a full polysomnographic array or at least one electroencephalographic, electrooculographic, electrocardiographic, or electromyelographic channel thereof. Sensor 156(a) may be operably coupled to data controller 140 in order to collect, and provide first input dataset 102 with, at least one additional element of data specific to at least one patient for processing by patient profile module 110. Sensor 156(a) can be operably coupled to data controller 140 in order to collect, and provide second input dataset 104 with, at least one additional element of data specific to the healthcare facility for processing by service delivery module 112 or resource allocation module 114. Sensor 156(a) can be configured to monitor at least one stress inducer related to sleep cycle disruption of at least one patient subsequent to admission. A stress inducer may include, but is not limited to, a sensory input such as a noise, a light, a movement, a touch, e.g., from a person or machinery.

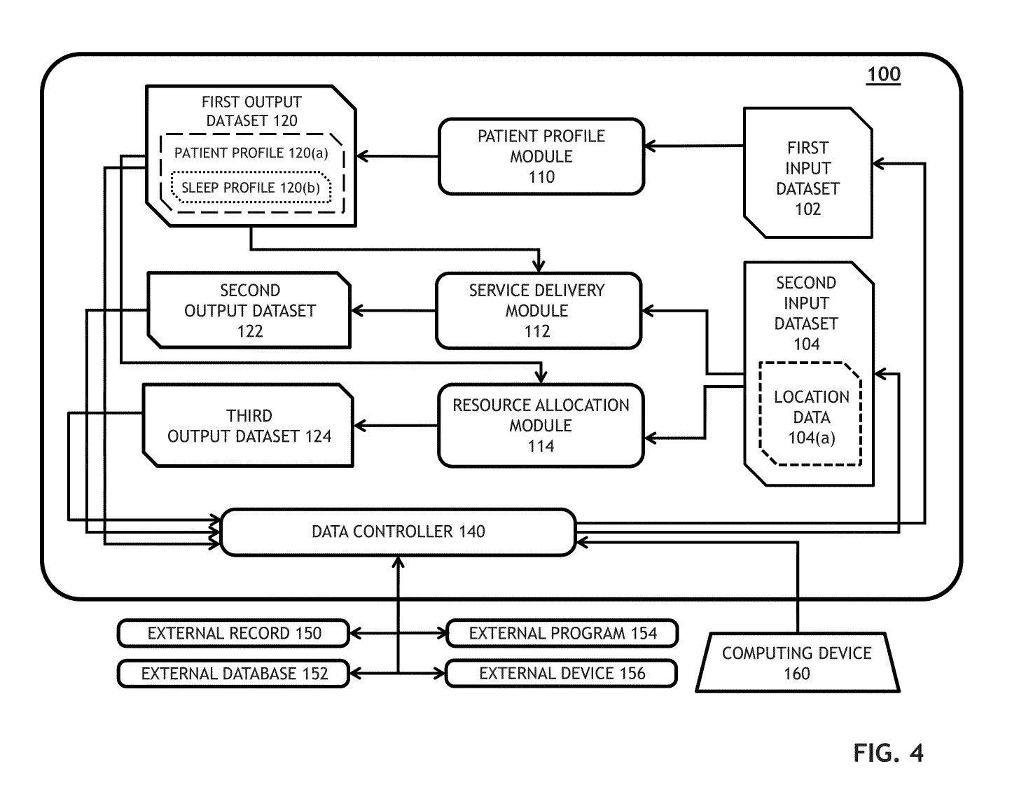

In an embodiment, illustrated in FIG. 4, data controller 140 is configured to receive at least one element of input data from an end user. An end user can include at least one of an administrator, a health care provider, an individual authorized by a health care facility, and in some embodiments can include another computing device. Receiving at least one element of data can include, but is not limited to, manual entry by at least one keyboard or other peripheral device operably connected to a computing device 160.

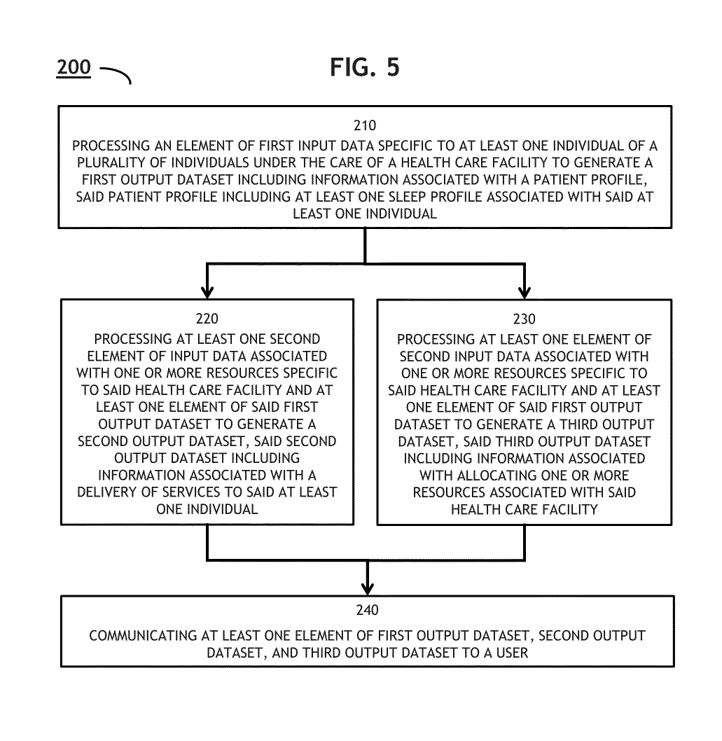

FIGS. 5 to 62 are a series of flowcharts depicting implementations of processes. For ease of understanding, the flowcharts are organized such that the initial flowchart presents implementations via an overall “big picture” viewpoint and thereafter the following flowcharts present alternate implementations or expansions of the “big picture” flowchart as either sub-steps or additional steps building on one or more earlier-presented flowcharts. The style of presentation utilized herein (e.g., beginning with a presentation of a flowchart(s) presenting an overall view and thereafter providing additions to or further details in subsequent flowcharts) generally allows for a rapid and easy understanding of the various process implementations.

FIG. 5 illustrates an operational flow 200 representing example operations related to managing service delivery and resource allocation by a health care facility. In FIG. 5 and in following figures that include various examples of operational flows, discussion and explanation may be provided with respect to the above-described examples of FIGS. 1 through 4, or with respect to other examples and contexts. However, it should be understood that the operational flows may be executed in a number of other environments and contexts, or in modified versions of FIGS. 1 through 4. Also, although the various operational flows are presented in the sequence(s) illustrated, it should be understood that the various operations may be performed in orders other than those that are illustrated, or may be performed concurrently. Operation 210 depicts processing an element of first input data 102 specific to at least one individual of a plurality of individuals under the care of a health care facility to generate a first output dataset 120 including information associated with a patient profile 120(a), said patient profile 120(a) including at least one sleep profile 120(b) associated with said at least one individual. Operation 220 depicts processing at least one second element of input data 104 associated with one or more resources specific to said health care facility and at least one element of said first output dataset 120 to generate a second output dataset 122, said second output dataset including information associated with a delivery of services to said at least one individual. Alternative operation 230 depicts processing at least one element of second input data 104 associated with one or more resources specific to said health care facility and at least one element of said first output dataset 120 to generate a third output dataset 124, said third output dataset 124 including information associated with allocating one or more resources associated with said health care facility. Operation 240 depicts communicating at least one of an element of first output dataset 120, second output dataset 122, and third output dataset 124 to a user.

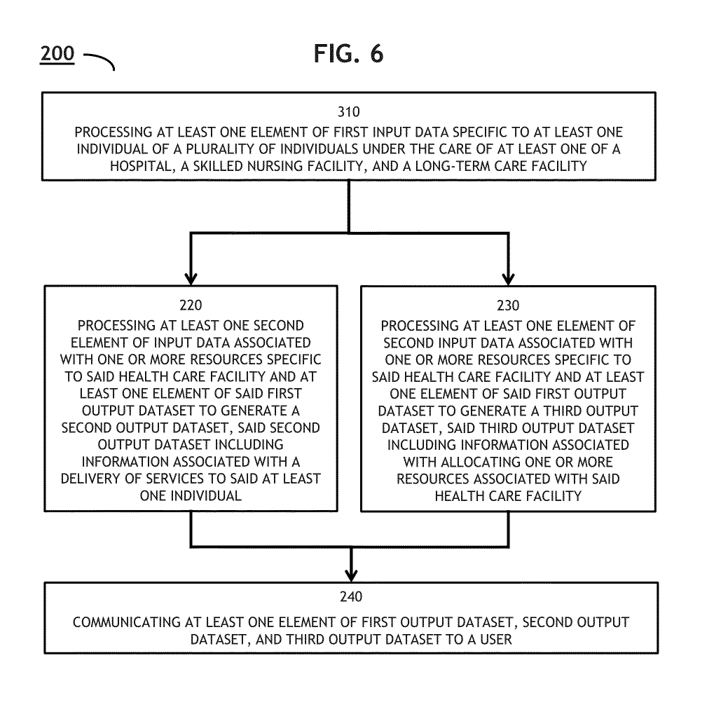

FIG. 6 illustrates an alternative embodiment of operational flow 200 as depicted in FIG. 5. In alternative operation 310, processing at least one element of first input data 102 includes processing at least one element of first input data 102 specific to at least one individual of a plurality of individuals under the care of at least one of a hospital, a skilled nursing facility, and a long-term care facility.

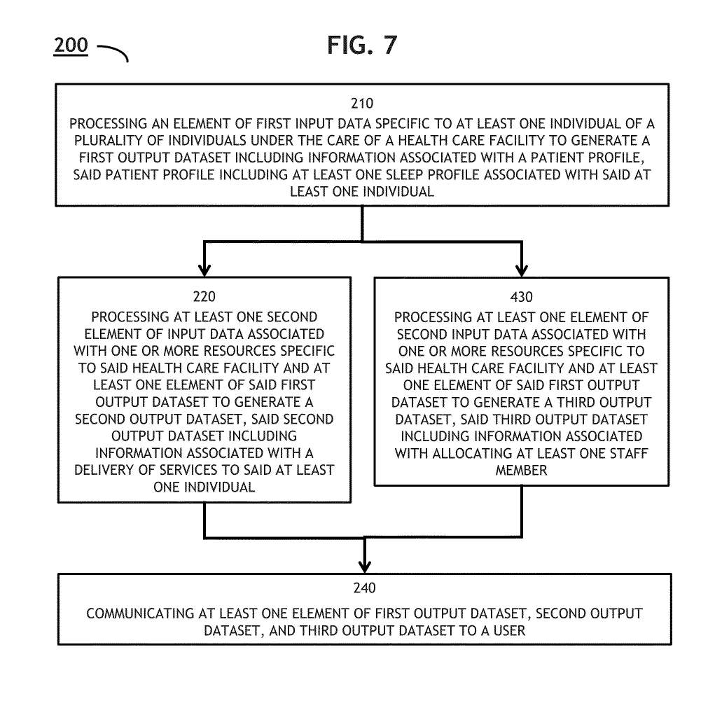

FIG. 7 illustrates an alternative embodiment of operational flow 200 as depicted in FIG. 5. In alternative operation 430, generating a third output dataset 124, said third output dataset 124 including information associated with allocating one or more resources associated with said health care facility includes generating a third output dataset 124, said third output dataset 124 including information associated with allocating at least one staff member.

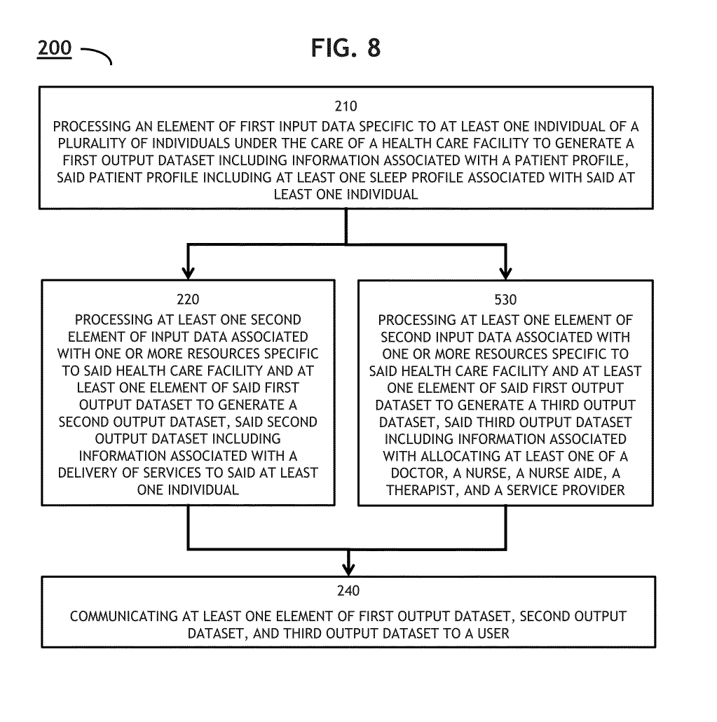

FIG. 8 illustrates an alternative embodiment of operational flow 200 as depicted in FIG. 7. In alternative operation 530, generating a third output dataset 124, said third output dataset 124 including information associated with allocating at least one staff member includes generating a third output dataset 124, said third output dataset 124 including information associated with allocating at least one of a physician, a nurse, a nurse aide, a therapist, and a service provider.

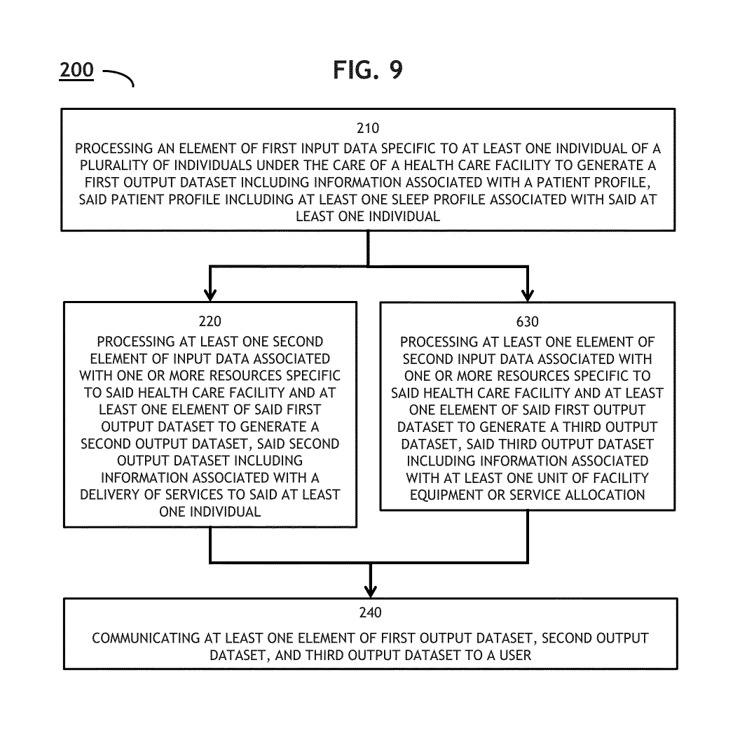

FIG. 9 depicts an alternative embodiment of operational flow 200 as depicted in FIG. 5. In alternative operation 630, generating a third output dataset 124, said third output dataset 124 including information associated with one or more of a resource allocation associated with said health care facility includes generating a third output dataset 124, said third output dataset 124 including information associated with at least one unit of facility equipment or service allocation.

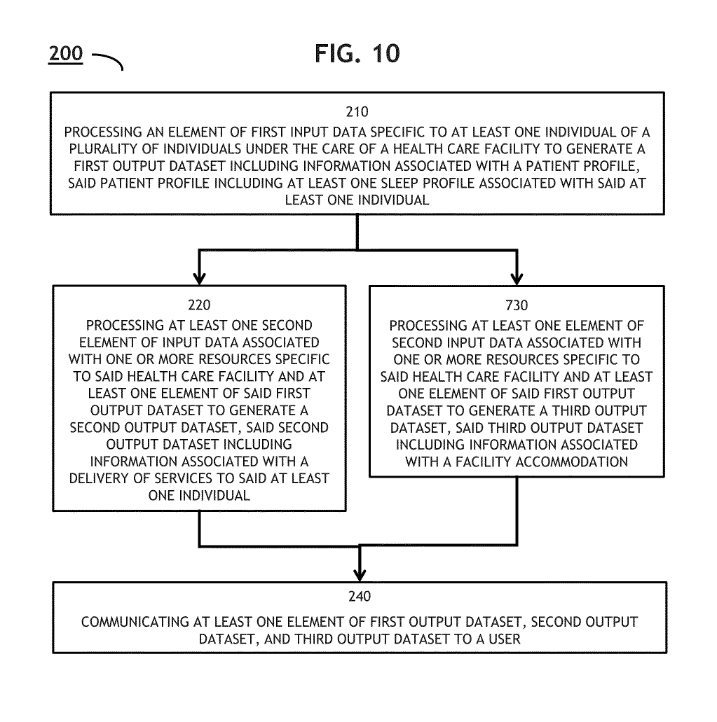

FIG. 10 depicts an alternative embodiment of operational flow 200 as depicted in FIG. 5. In alternative operation 730, generating a third output dataset 124, said third output dataset 124 including information associated with one or more of a resource allocation includes generating a third output dataset 124, said third output dataset 124 including information associated with a facility accommodation.

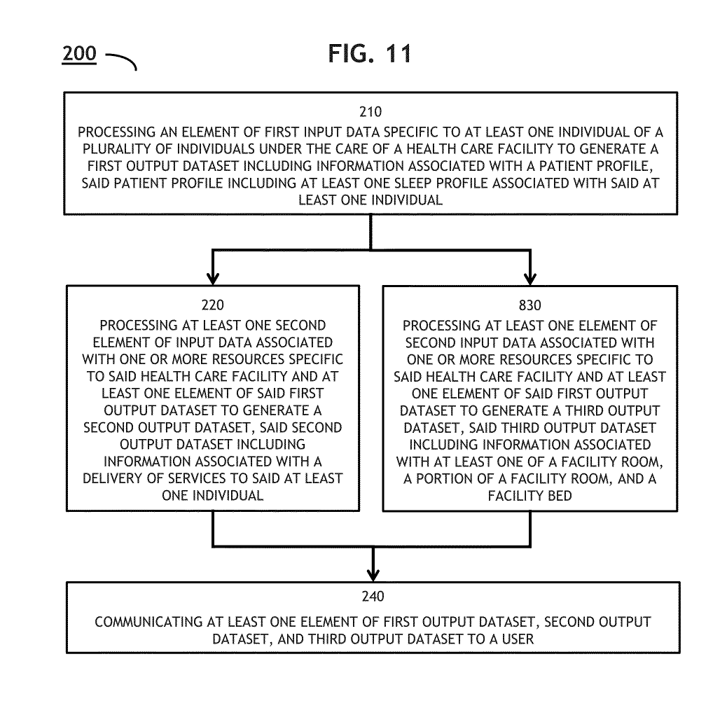

FIG. 11 depicts an alternative embodiment of operational flow 200 as depicted in FIG. 10. In alternative operation 830, generating a third output dataset 124, said third output dataset 124 including information associated with a facility accommodation includes generating a third output dataset 124, said third output dataset 124 including information associated with at least one of a facility room, a portion of a facility room, and a facility bed.

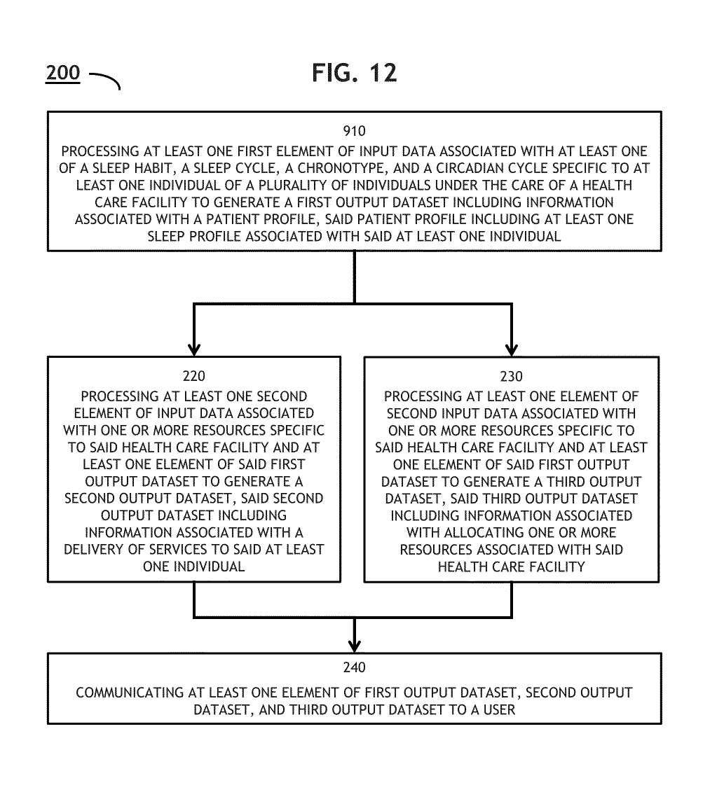

FIG. 12 depicts an alternative embodiment of operational flow 200 as depicted in FIG. 5. In alternative operation 910, processing an element of first input data 102 specific to at least one individual of a plurality of individuals under the care of a health care facility to generate a first output dataset 120 includes processing at least one first element of input data 102 associated with at least one of a sleep habit, a sleep cycle, a chronotype, and a circadian cycle for said at least one individual.

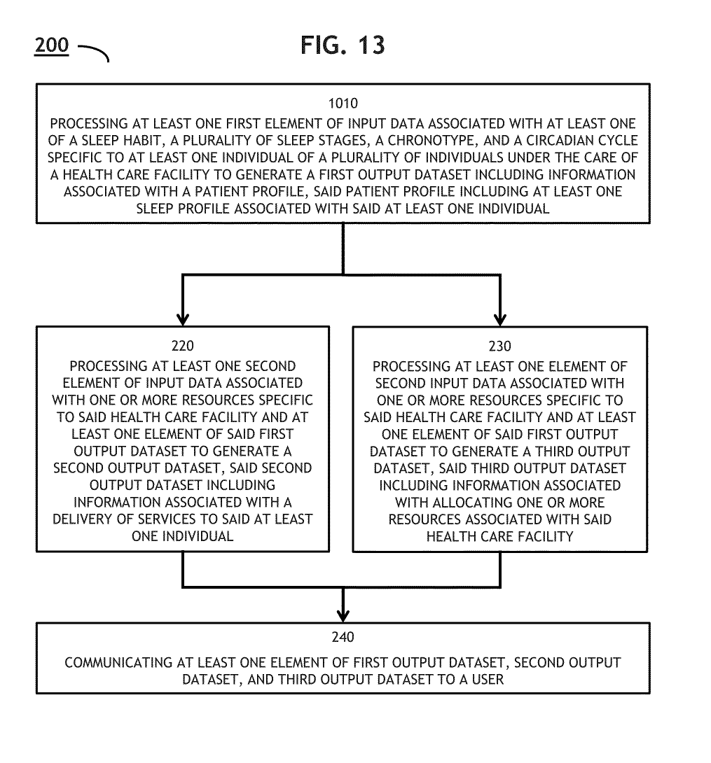

FIG. 13 depicts an alternative embodiment of operational flow 200 as depicted in FIG. 12. In alternative operation 1010, processing at least one first element of input data 102 related to at least one of a sleep habit, a sleep cycle, a chronotype, and a circadian cycle for said at least one individual includes processing at least one first element of input data 102 associated with at least one of a sleep habit, a plurality of sleep stages, a chronotype, and a circadian cycle for said at least one individual.

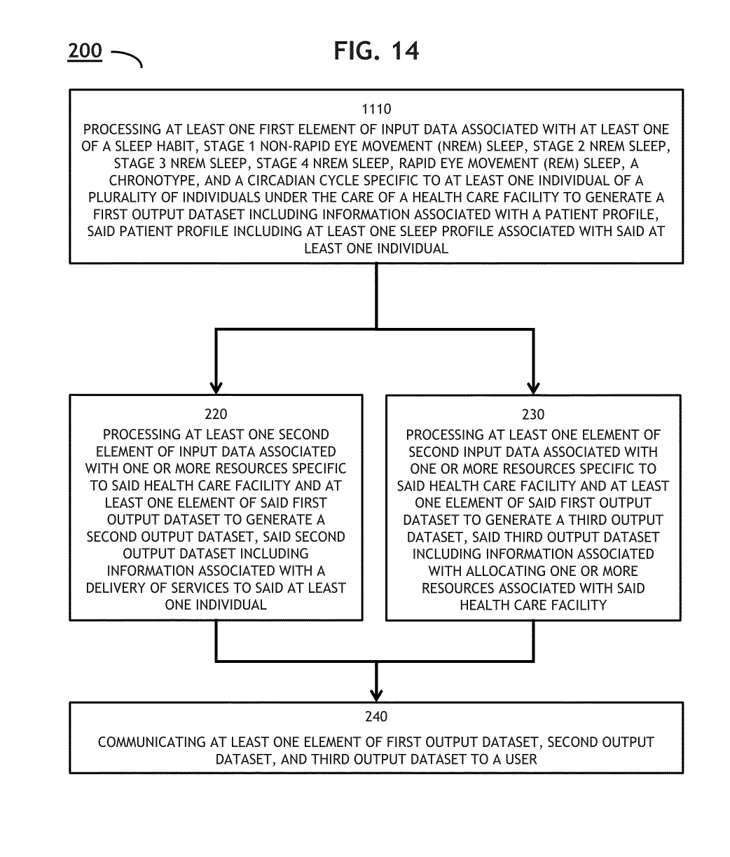

FIG. 14 depicts an alternative embodiment of operational flow 200 as depicted in FIG. 13. In alternative operation 1110, processing at least one first element of input data 102 associated with at least one of a sleep habit, a plurality of sleep stages, a chronotype, and a circadian cycle for said at least one individual includes processing at least one first element of input data 102 associated with at least one of a sleep habit, stage 1 non-rapid eye movement (NREM) sleep, stage 2 NREM sleep, stage 3 NREM sleep, stage 4 NREM sleep, rapid eye movement (REM) sleep, a chronotype, and a circadian cycle for said at least one individual.

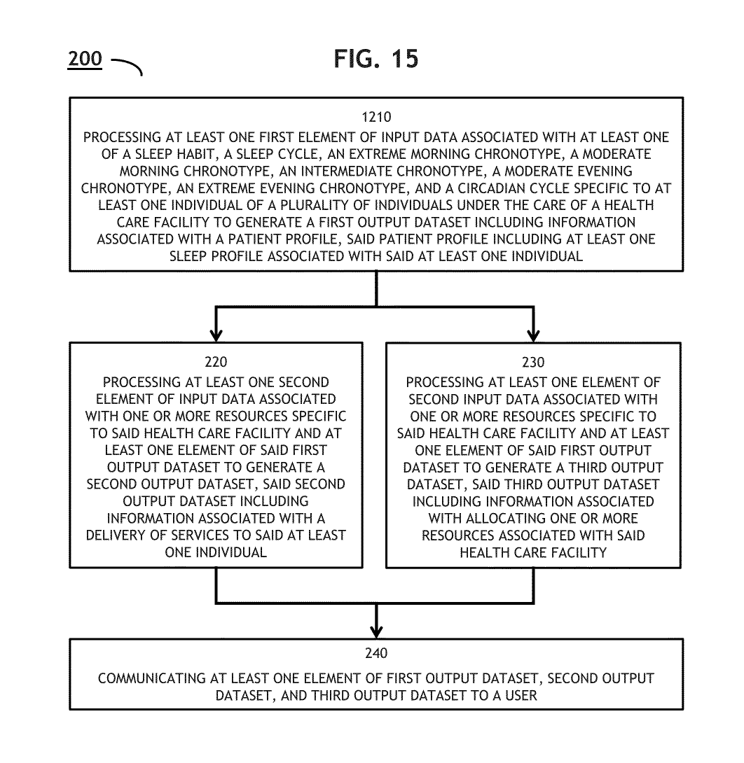

FIG. 15 depicts an alternative embodiment of operational flow 200 as depicted in FIG. 12. In alternative operation 1210, processing at least one first element of input data 102 associated with at least one of a sleep habit, a sleep cycle, a chronotype, and a circadian cycle for said at least one individual includes processing at least one first element of input data 102 associated with at least one of a sleep habit, a sleep cycle, an extreme morning chronotype, a moderate morning chronotype, an intermediate chronotype, a moderate evening chronotype, an extreme evening chronotype, and a circadian cycle for said at least one individual.

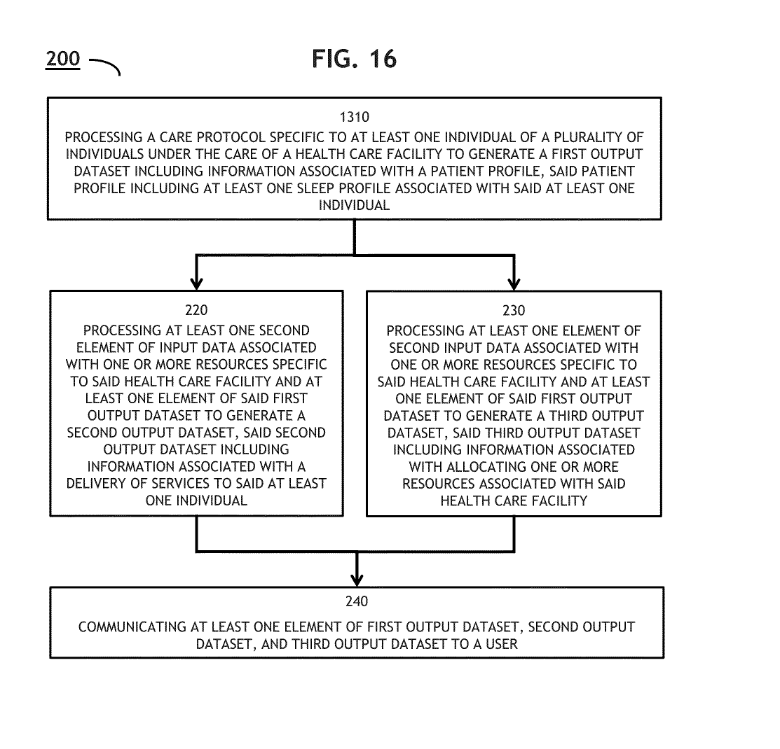

FIG. 16 depicts an alternative embodiment of operational flow 200 as depicted in FIG. 5. In alternative operation 1310, processing an element of first input data 102 specific to at least one individual of a plurality of individuals under the care of a health care facility to generate a first output dataset 120 includes processing a care protocol specific to said at least one individual.

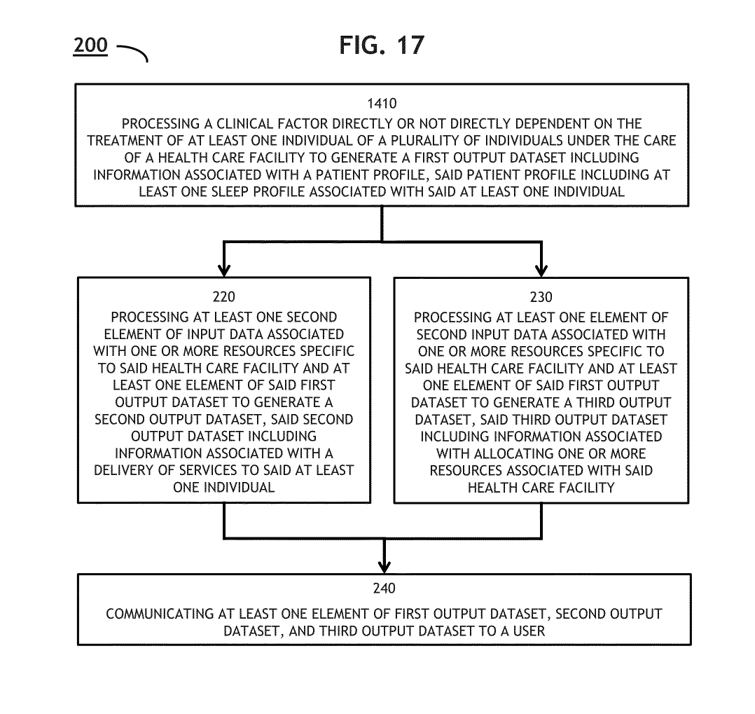

FIG. 17 depicts an alternative embodiment of operational flow 200 as depicted in FIG. 5. In alternative operation 1410, processing an element of first input data 102 specific to at least one individual of a plurality of individuals under the care of a health care facility to generate a first output dataset 120 includes processing a clinical factor directly or not directly dependent on the treatment of said at least one individual.

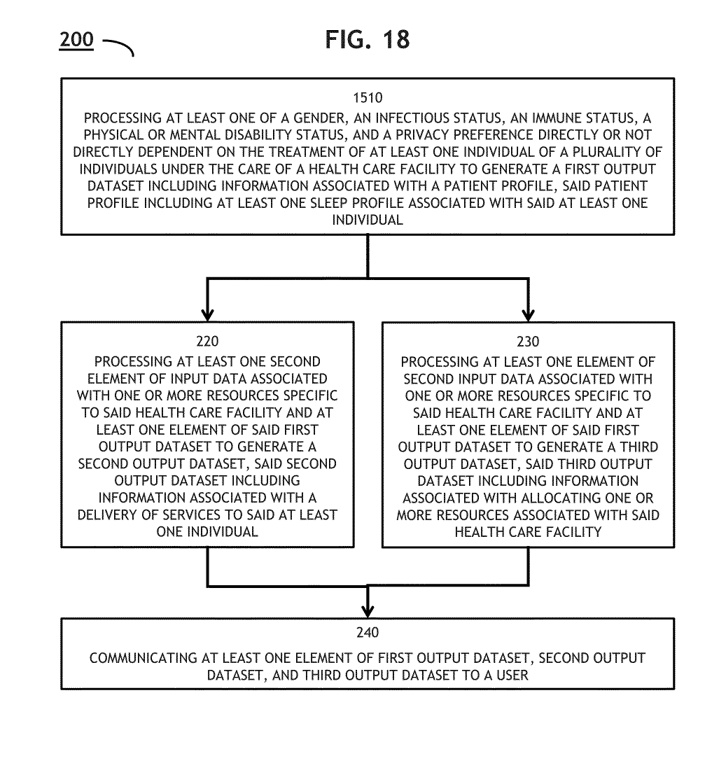

FIG. 18 depicts an alternative embodiment of operational flow 200 as depicted in FIG. 17. In alternative operation 1510, processing a clinical factor directly or not directly dependent on the treatment of said at least one individual includes processing at least one of a gender, an infectious status, an immune status, a physical or mental disability status, and a privacy preference directly or not directly dependent on the treatment of said at least one individual.

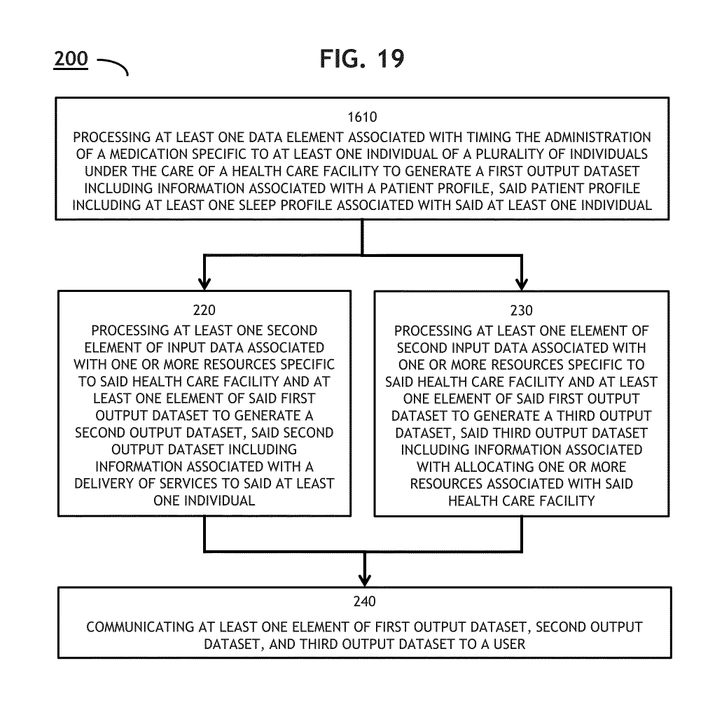

FIG. 19 depicts an alternative embodiment of operational flow 200 as depicted in FIG. 5. In alternative operation 1610, processing an element of first input data 102 specific to at least one individual of a plurality of individuals under the care of a health care facility to generate a first output dataset 120 includes processing at least one data element associated with timing the administration of a medication.

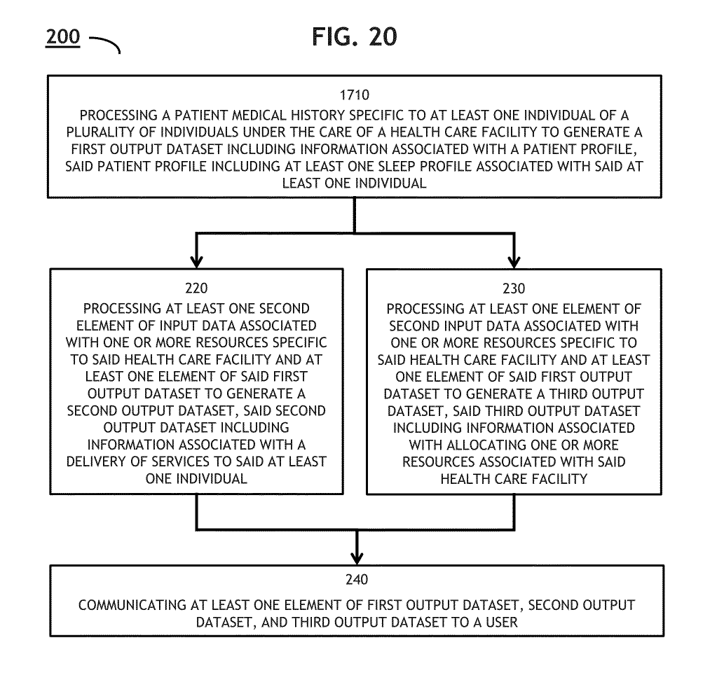

FIG. 20 depicts an alternative embodiment of operational flow 200 as depicted in FIG. 5. In alternative operation 1710, processing an element of first input data 102 specific to at least one individual of a plurality of individuals under the care of a health care facility to generate a first output dataset 120 includes processing a patient medical history.

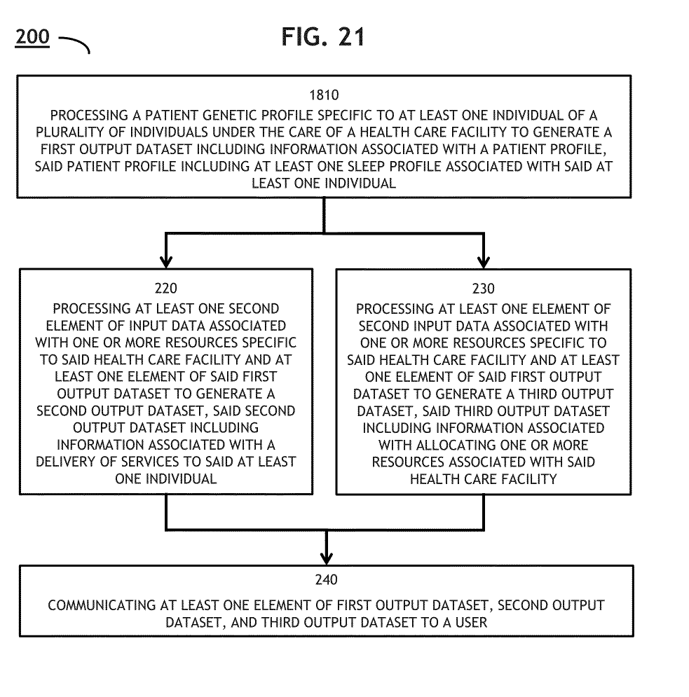

FIG. 21 depicts an alternative embodiment of operational flow 200 as depicted in FIG. 5. In alternative operation 1810, processing an element of first input data 102 specific to at least one individual of a plurality of individuals under the care of a health care facility to generate a first output dataset 120 includes processing a patient genetic profile.

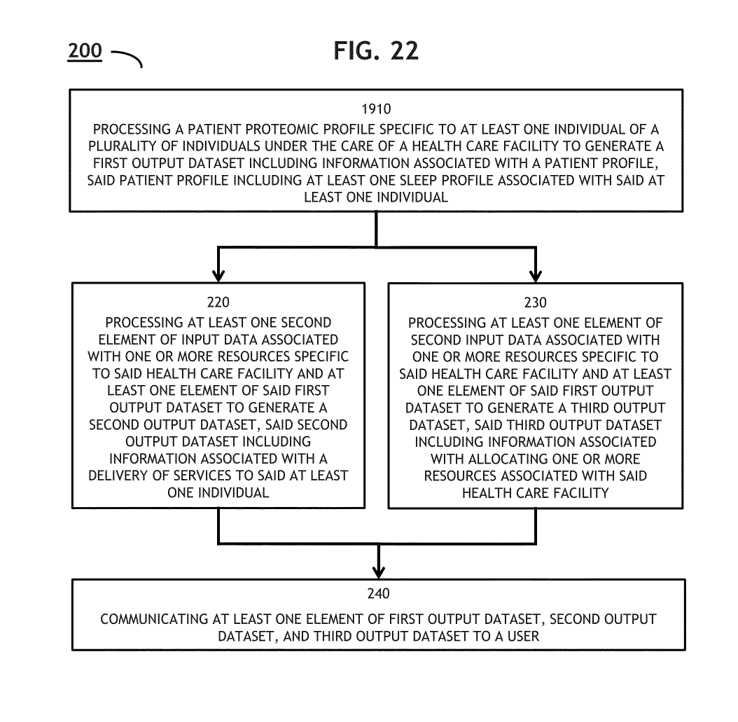

FIG. 22 depicts an alternative embodiment of operational flow 200 as depicted in FIG. 5. In alternative operation 1910, processing an element of first input data 102 specific to at least one individual of a plurality of individuals under the care of a health care facility to generate a first output dataset 120 includes processing a patient proteomic profile.

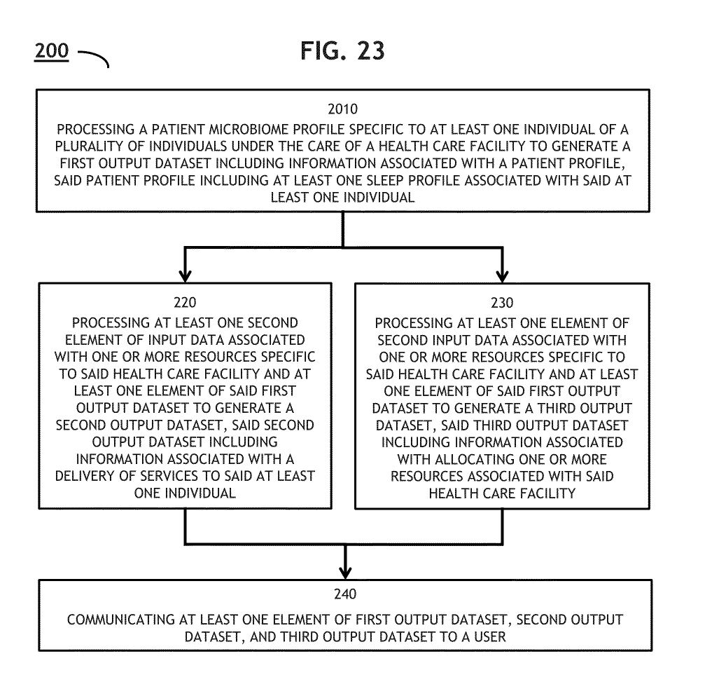

FIG. 23 depicts an alternative embodiment of operational flow 200 as depicted in FIG. 5. In alternative operation 2010, processing an element of first input data 102 specific to at least one individual of a plurality of individuals under the care of a health care facility to generate a first output dataset 120 includes processing a patient microbiome profile.

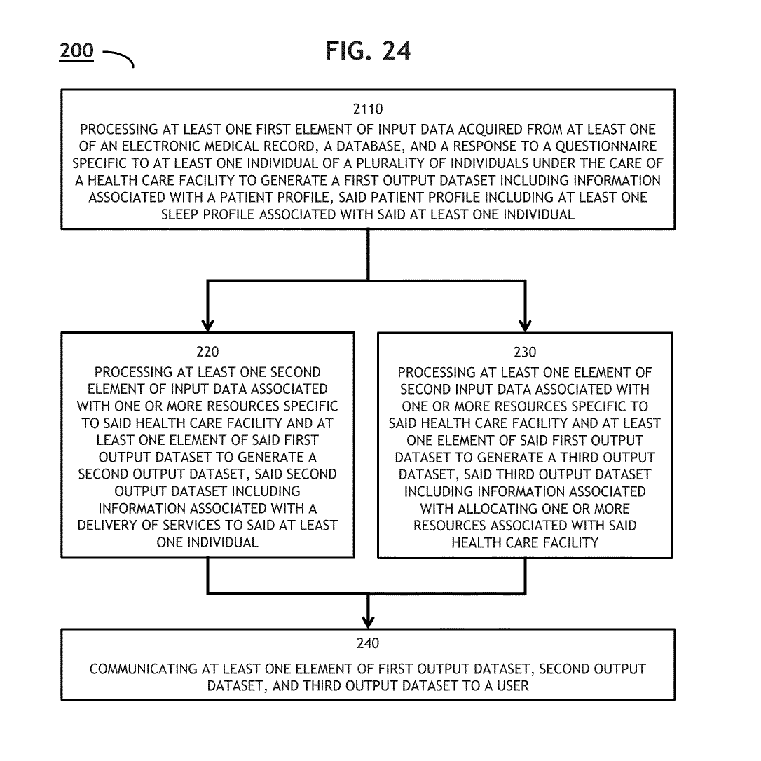

FIG. 24 depicts an alternative embodiment of operational flow 200 as depicted in FIG. 5. In alternative operation 2110, processing an element of first input data 102 specific to at least one individual of a plurality of individuals under the care of a health care facility to generate a first output dataset 120 includes processing at least one first element of input data acquired from at least one of an electronic medical record, a database, and a response to a questionnaire.

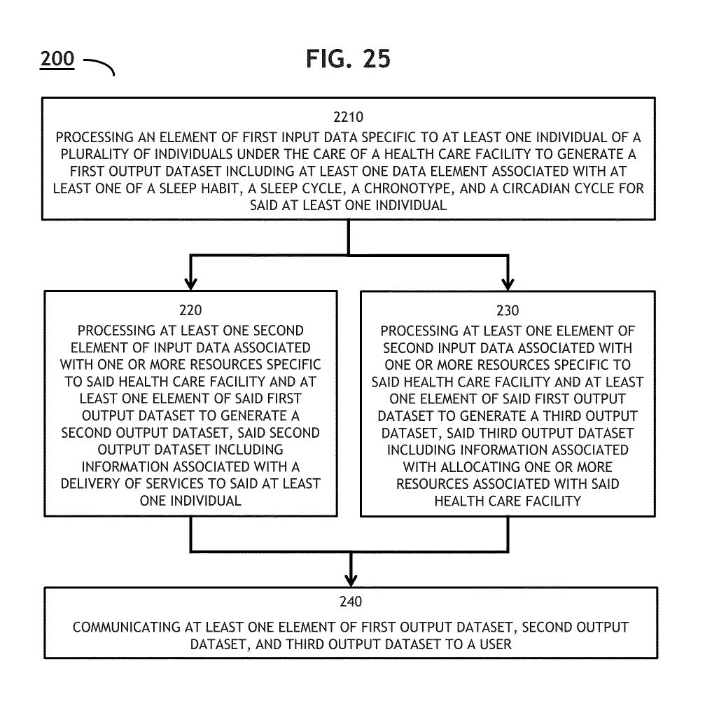

FIG. 25 depicts an alternative embodiment of operational flow 200 as depicted in FIG. 5. In alternative operation 2210, generating a first output dataset 120 including information associated with a patient profile 120(a), said patient profile 120(a) including at least one sleep profile 120(b) associated with said at least one individual includes generating a first output dataset 120 including at least one data element associated with at least one of a sleep habit, a sleep cycle, a chronotype, and a circadian cycle for said at least one individual.

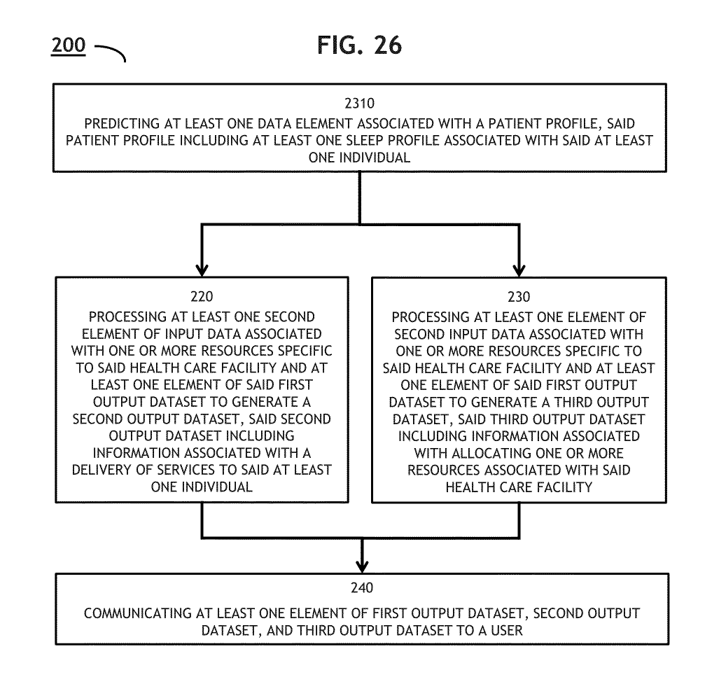

FIG. 26 depicts an alternative embodiment of operational flow 200 as depicted in FIG. 5. In alternative operation 2310, generating a first output dataset 120 including information associated with a patient profile 120(a), said patient profile 120(a) including at least one sleep profile 120(b) associated with said at least one individual includes predicting at least one data element associated with a patient profile 120(a).

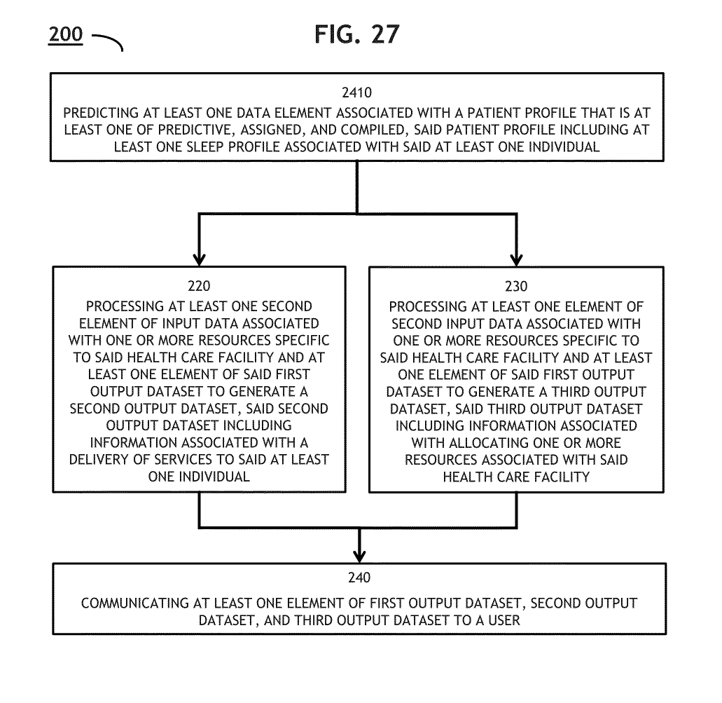

FIG. 27 depicts an alternative embodiment of operational flow 200 as depicted in FIG. 26. In alternative operation 2410, predicting at least one data element associated with a patient profile 120(a) includes predicting at least one data element that is at least one of predictive, assigned, and compiled.

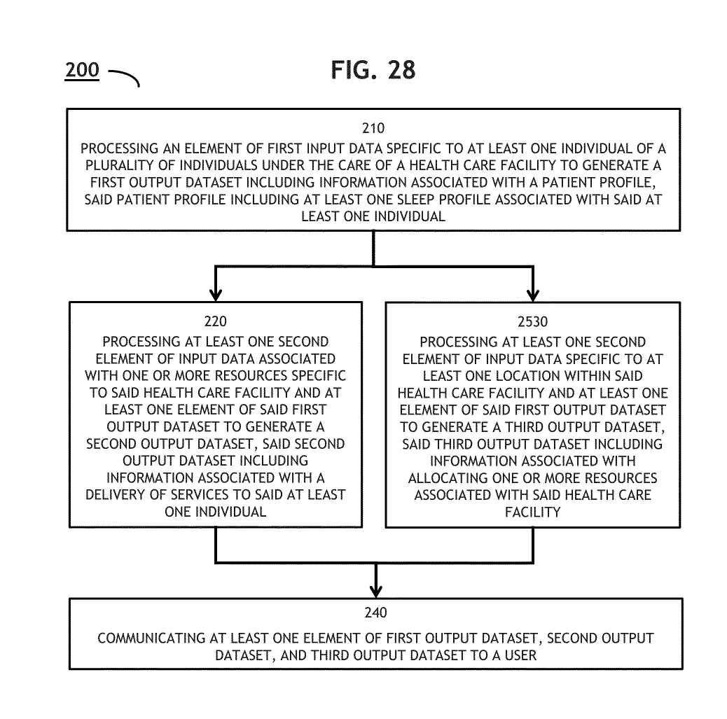

FIG. 28 depicts an alternative embodiment of operational flow 200 as depicted in FIG. 5. In alternative operation 2530, processing at least one second element of input data 104 associated with one or more resources specific to said health care facility and at least one element of said first output dataset 120 to generate a second output dataset 122 includes processing at least one second element of input data 104(a) specific to at least one location within said health care facility.

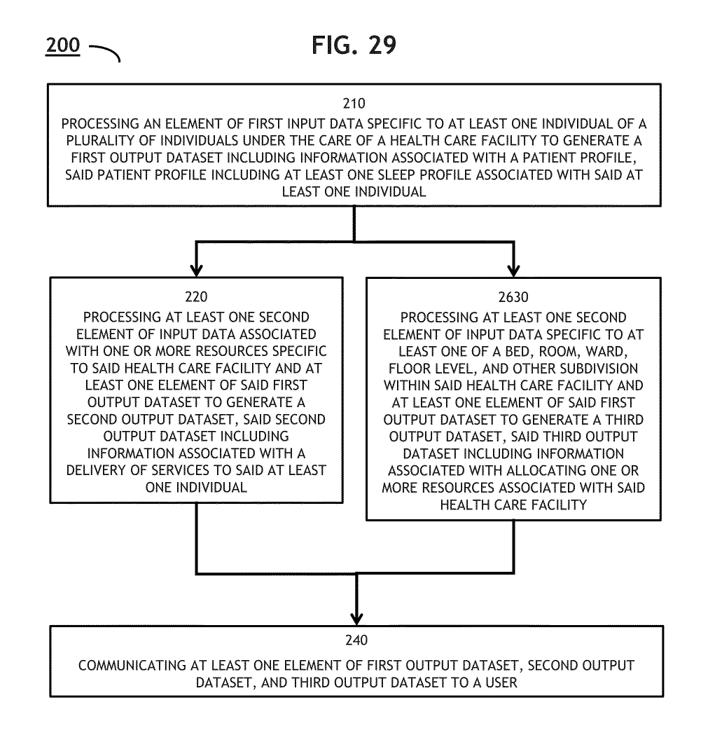

FIG. 29 depicts an alternative embodiment of operational flow 200 as depicted in FIG. 28. In alternative operation 2630, processing at least one second element of input data 104(a) specific to at least one location within said health care facility includes processing at least one second element of input data 104(a) specific to at least one of a bed, room, ward, floor level, and other subdivision within said health care facility.

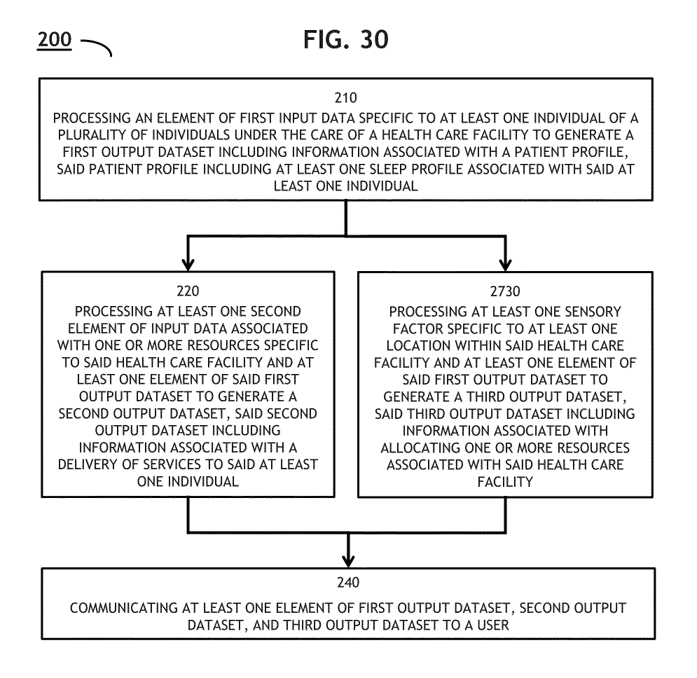

FIG. 30 depicts an alternative embodiment of operational flow 200 as depicted in FIG. 28. In alternative operation 2730, processing at least one second element of input data 104(a) specific to at least one location within said health care facility includes processing at least one sensory factor specific to said at least one location.

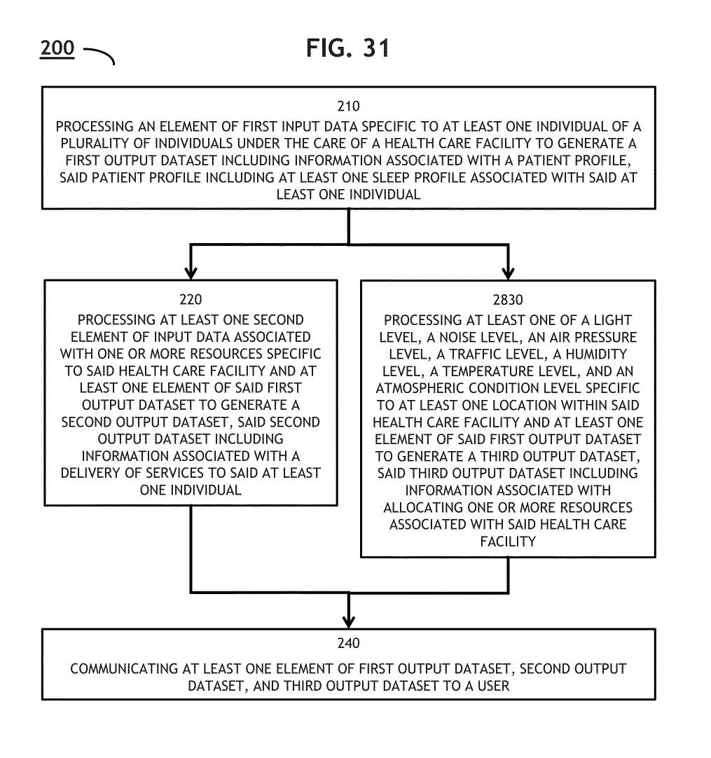

FIG. 31 depicts an alternative embodiment of operational flow 200 as depicted in FIG. 30. In alternative operation 2830, processing at least one sensory factor specific to said at least one location includes processing at least one of a light level, a noise level, an air pressure level, a traffic level, a humidity level, a temperature level, and an atmospheric condition level.

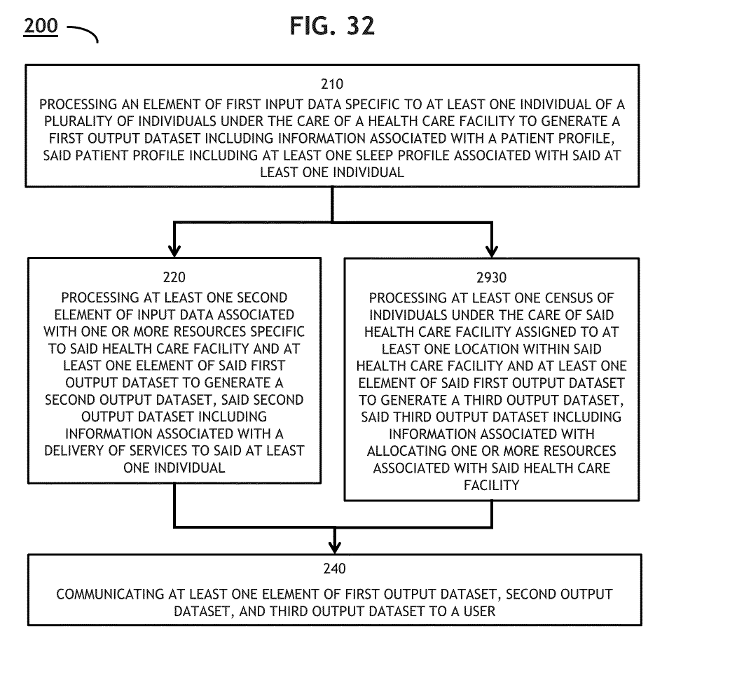

FIG. 32 depicts an alternative embodiment of operational flow 200 as depicted in FIG. 28. In alternative operation 2930 processing at least one second element of input data 104(a) specific to at least one location within said health care facility includes processing at least one census of individuals under the care of said health care facility assigned to said at least one location.

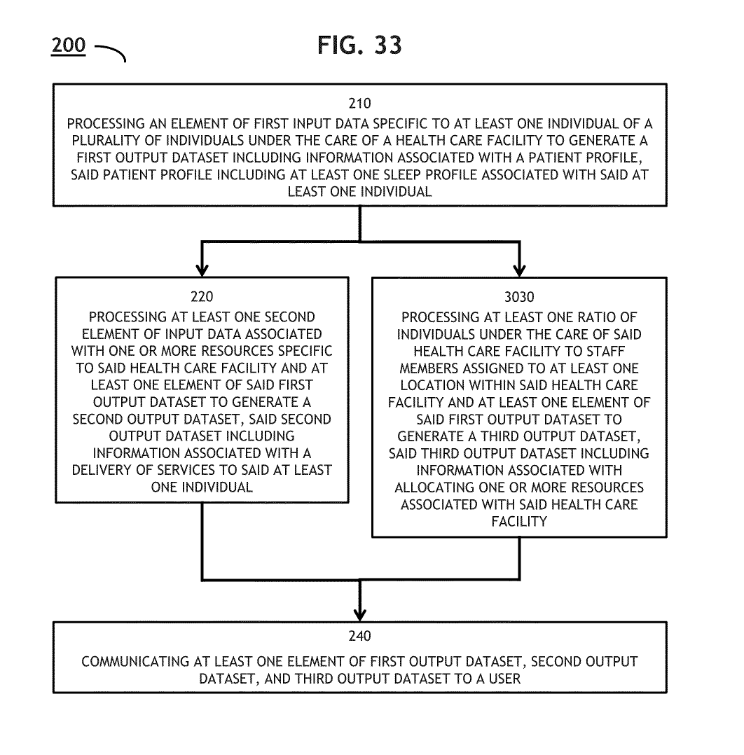

FIG. 33 depicts an alternative embodiment of operational flow 200 as depicted in FIG. 28. In alternative operation 3030 processing at least one second element of input data 104(a) specific to at least one location within said health care facility includes processing at least one ratio of individuals under the care of said health care facility to staff members assigned to said at least one location.

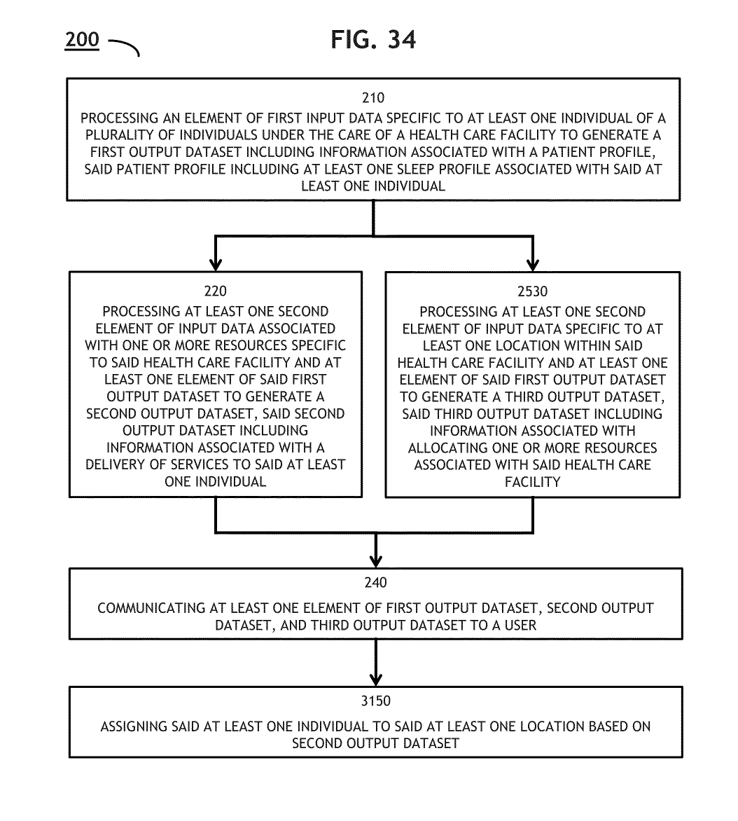

FIG. 34 depicts an alternative embodiment of operational flow 200 as depicted in FIG. 28. Operational flow 200 may have an additional operation 3150, comprising assigning said at least one individual to said at least one location based on said second output dataset 122.

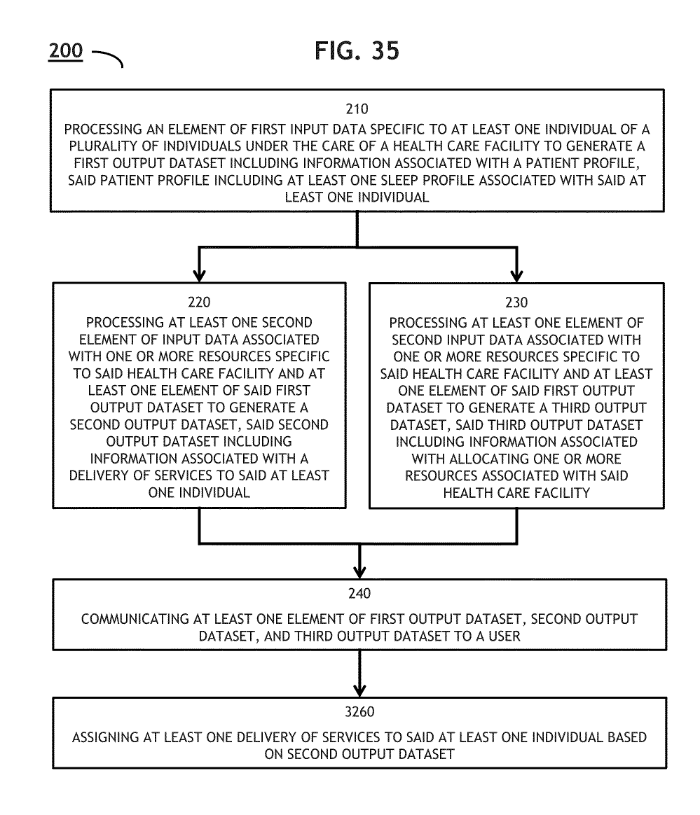

FIG. 35 depicts an alternative embodiment of operational flow 200 as depicted in FIG. 5. Operational flow 200 may have an additional operation 3260, comprising assigning at least one delivery of services to said at least one individual based on said second output dataset 122.

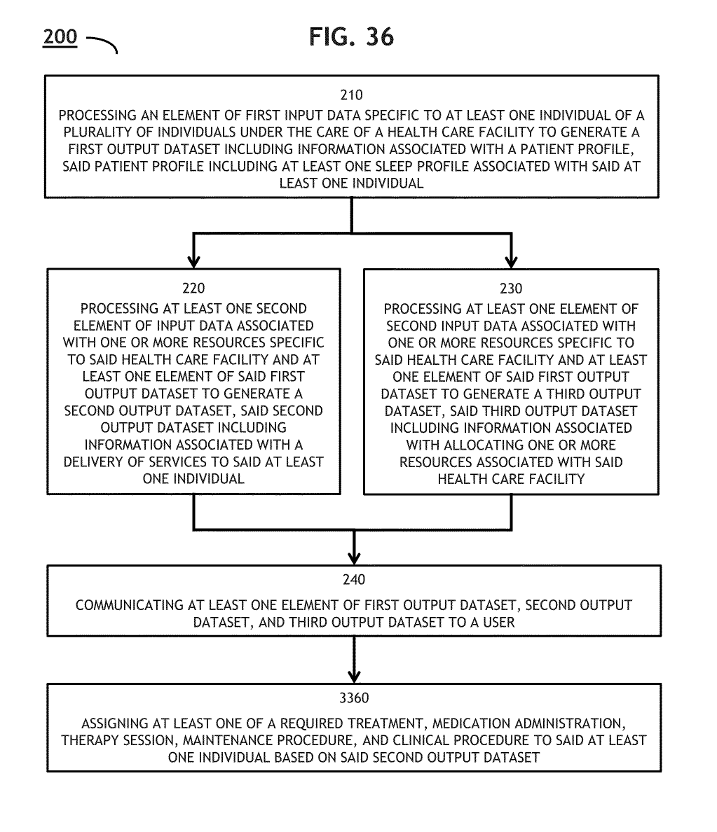

FIG. 36 depicts an alternative embodiment of operational flow 200 as depicted in FIG. 35. In alternative operation 3360, assigning at least one delivery of services to said at least one individual based on said second output dataset 122 includes assigning at least one of a required treatment, medication administration, therapy session, maintenance procedure, and clinical procedure to said at least one individual based on said second output dataset 122.

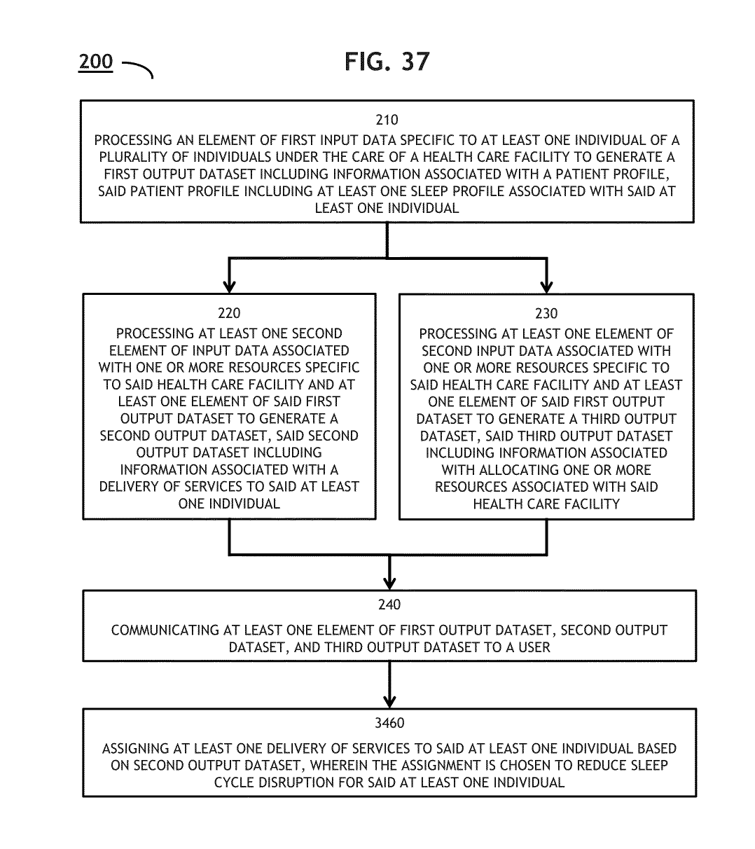

FIG. 37 depicts an alternative embodiment of operational flow 200 as depicted in FIG. 35. In alternative operation 3460, assigning at least one delivery of services to said at least one individual based on said second output dataset 122 includes assigning at least one delivery of services to said at least one individual based on said second output dataset 122, wherein the assignment is chosen to reduce sleep cycle disruption for said at least one individual.

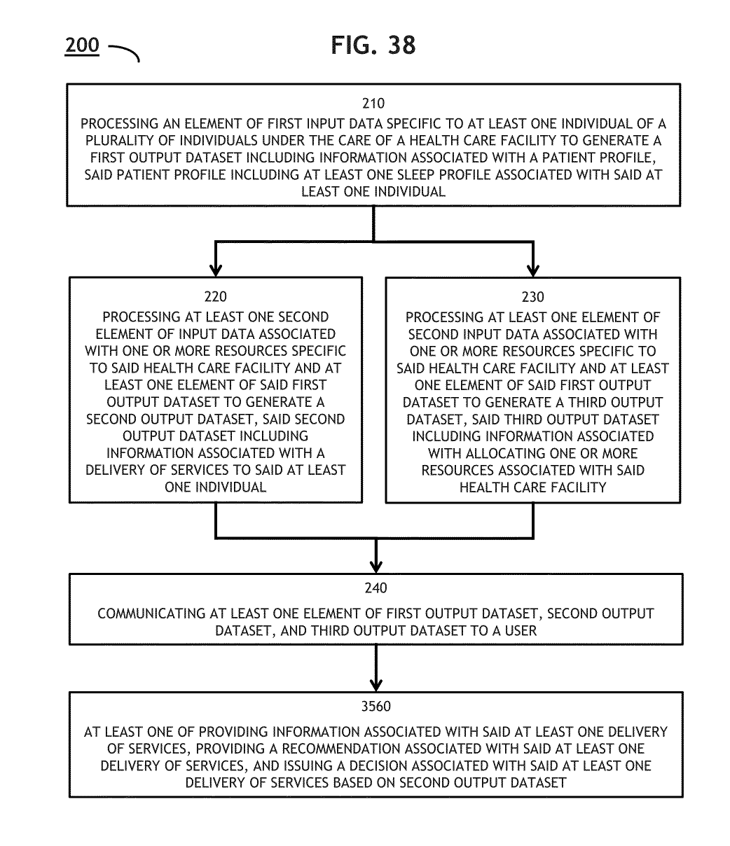

FIG. 38 depicts an alternative embodiment of operational flow 200 as depicted in FIG. 35. In alternative operation 3560, assigning at least one delivery of services to said at least one individual based on said second output dataset 122 includes at least one of providing information associated with said at least one delivery of services, providing a recommendation associated with said at least one delivery of services, and issuing a decision associated with said at least one delivery of services.

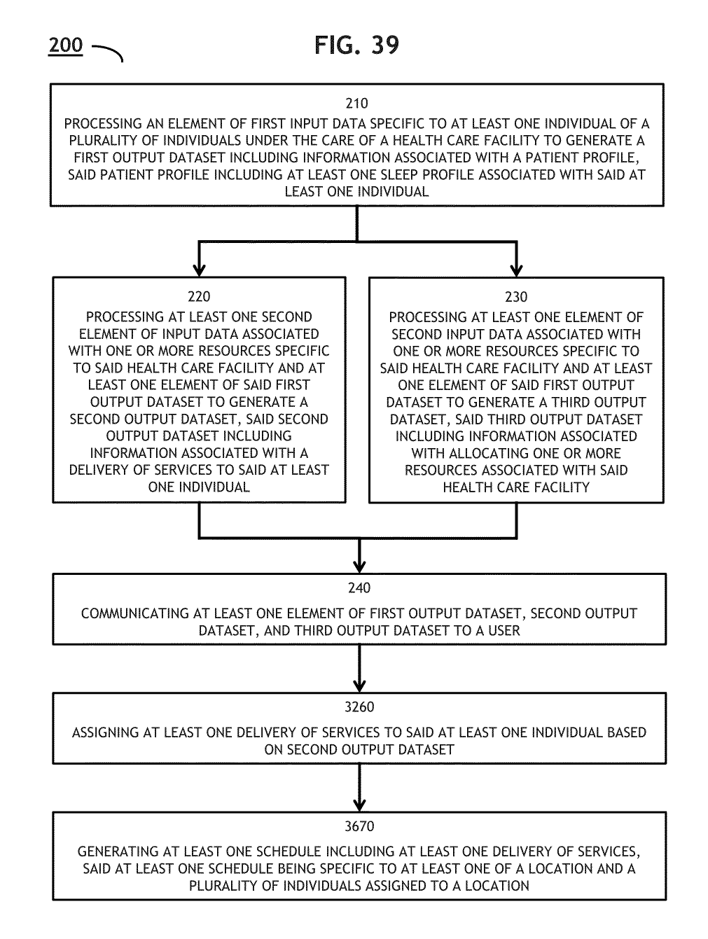

FIG. 39 depicts an alternative embodiment of operational flow 200 as depicted in FIG. 35. Operational flow 200 may have an additional operation 3670, comprising generating at least one schedule including at least one delivery of services, said at least one schedule being specific to at least one of a location and a plurality of individuals assigned to a location.

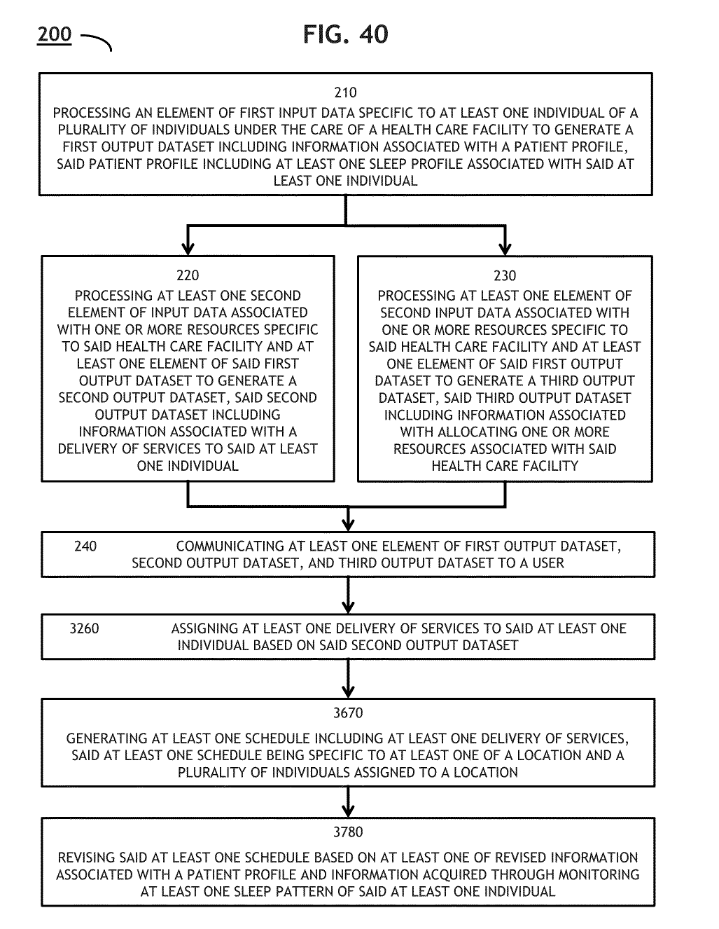

FIG. 40 depicts an alternative embodiment of operational flow 200 as depicted in FIG. 39. Operational flow 200 may have an additional operation 3780, comprising revising said at least one schedule based on at least one of revised information associated with a patient profile 120(a) and information acquired through monitoring at least one sleep pattern of said at least one individual.

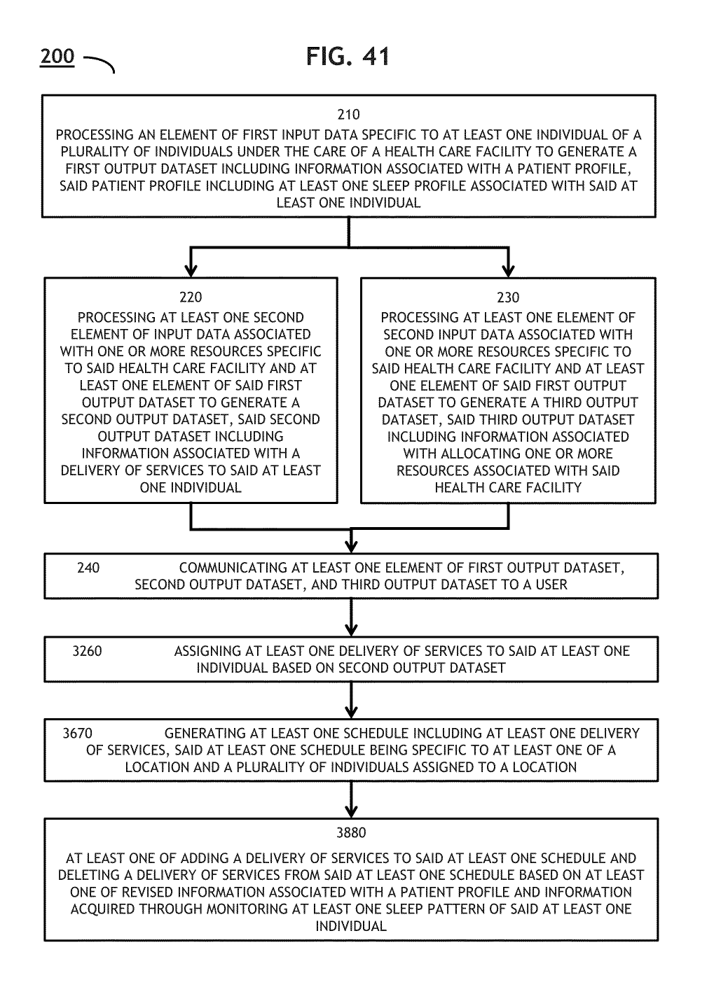

FIG. 41 depicts an alternative embodiment of operational flow 200 as depicted in FIG. 40. In alternative operation 3880, revising said at least one schedule includes at least one of adding a delivery of services to said at least one schedule and deleting a delivery of services from said at least one schedule.

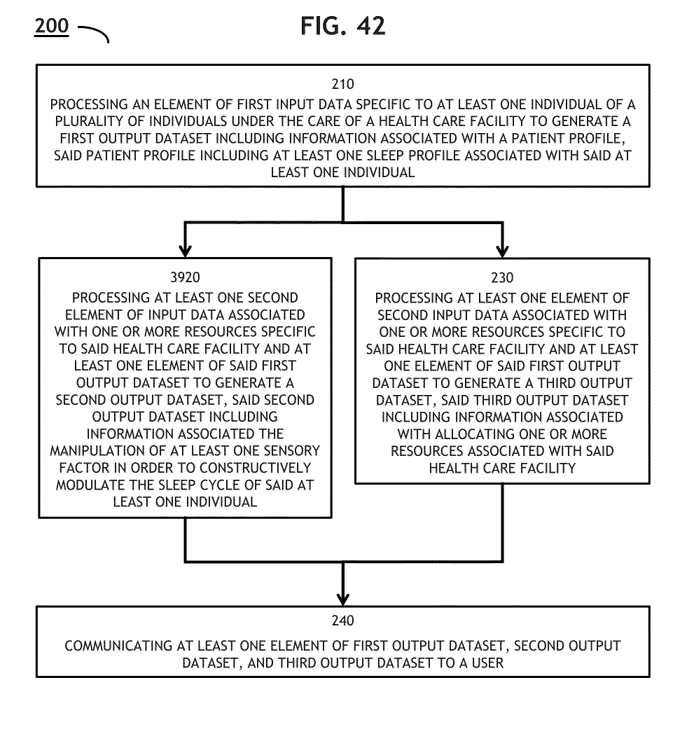

FIG. 42 depicts an alternative embodiment of operational flow 200 as depicted in FIG. 5. In alternative operation 3920, generating a second output dataset 122 including information associated with a delivery of services to said at least one individual includes generating a second output dataset 122 including information associated with the manipulation of at least one sensory factor in order to constructively modulate the sleep cycle of said at least one individual.

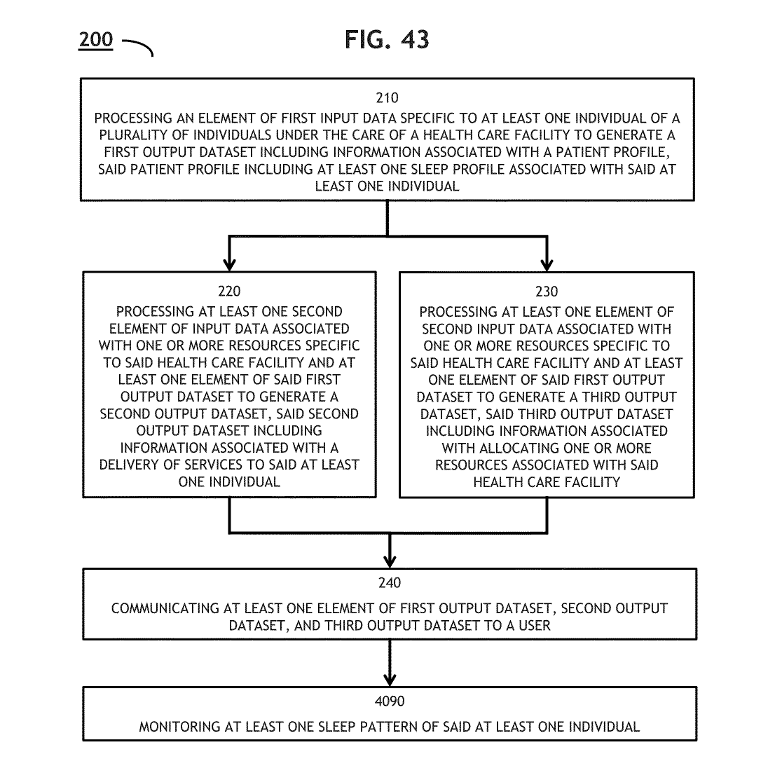

FIG. 43 depicts an alternative embodiment of operational flow 200 as depicted in FIG. 5. Operational flow 200 may have an additional operation 4090, comprising monitoring at least one sleep pattern of said at least one individual.

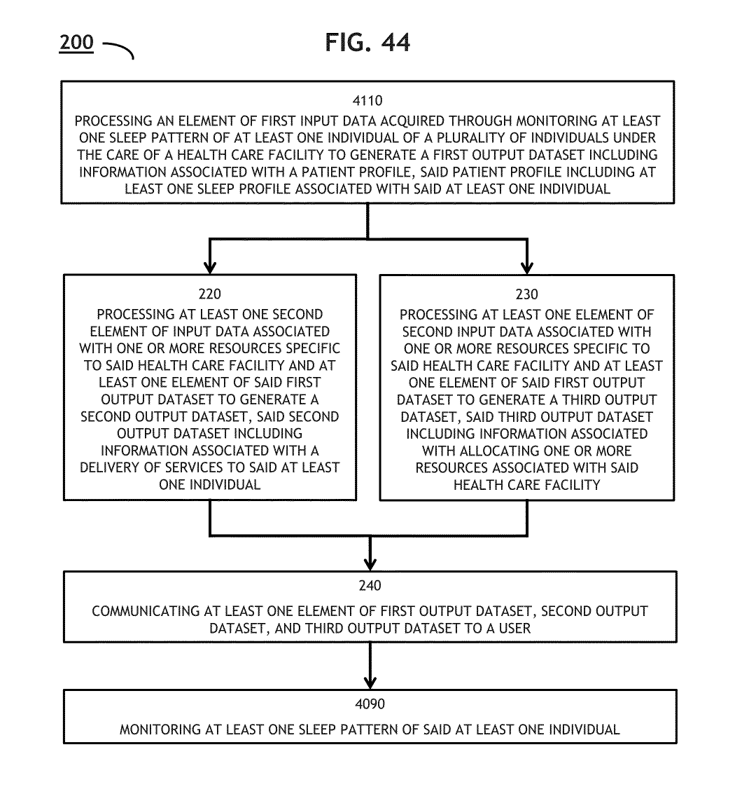

FIG. 44 depicts an alternative embodiment of operational flow 200 as depicted in FIG. 43. In alternative operation 4110, processing an element of first input data 102 specific to at least one individual of a plurality of individuals under the care of a health care facility to generate a first output dataset 120 includes processing at least one element of first input data 102 acquired through monitoring at least one sleep pattern of said at least one individual.

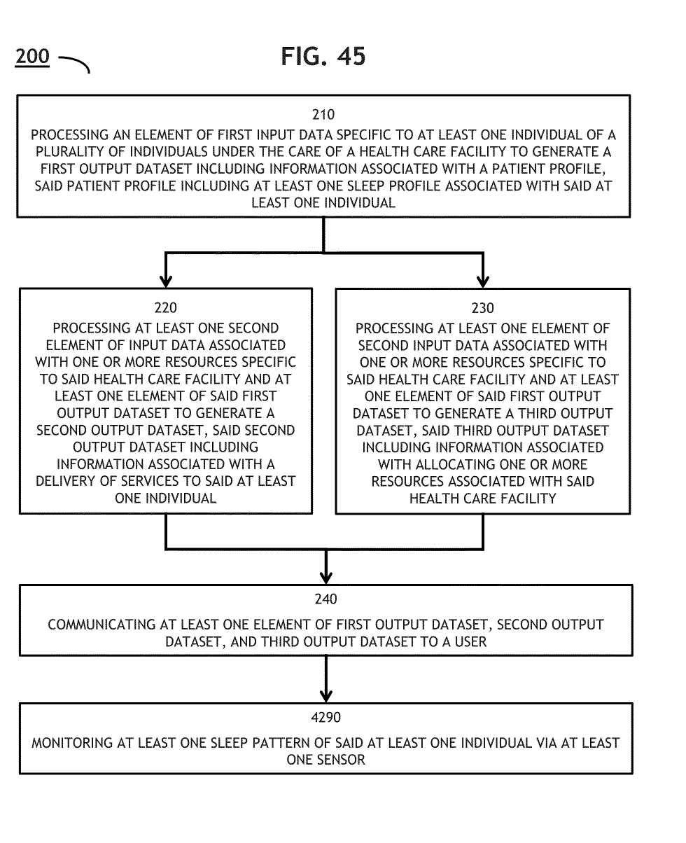

FIG. 45 depicts an alternative embodiment of operational flow 200 as depicted in FIG. 43. In alternative operation 4290, monitoring at least one sleep pattern of said at least one individual includes monitoring at least one sleep pattern of said at least one individual via at least one sensor 156(a).

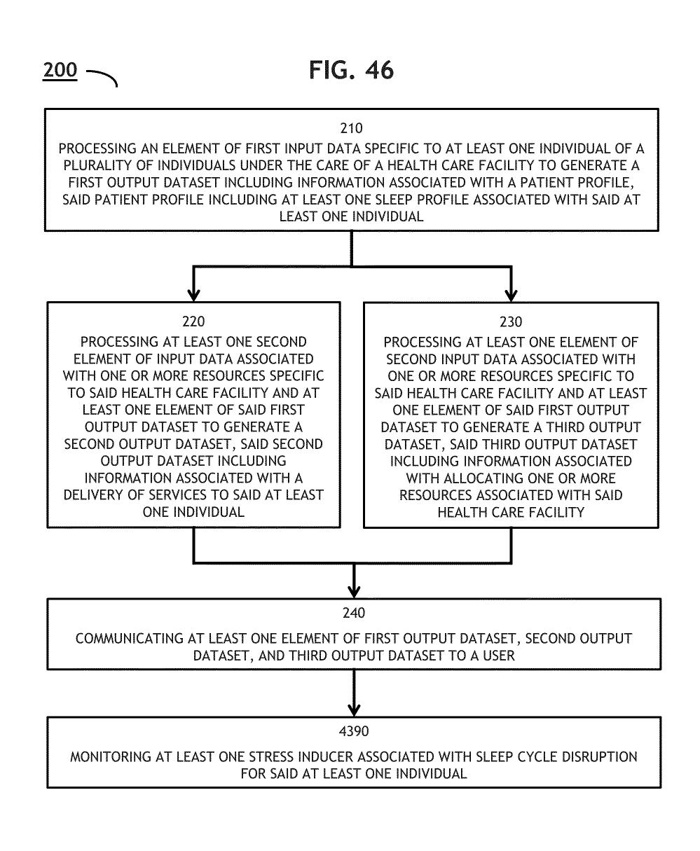

FIG. 46 depicts an alternative embodiment of operational flow 200 as depicted in FIG. 43. In alternative operation 4390, monitoring at least one sleep pattern of said at least one individual includes monitoring at least one stress inducer associated with sleep cycle disruption for said at least one individual.

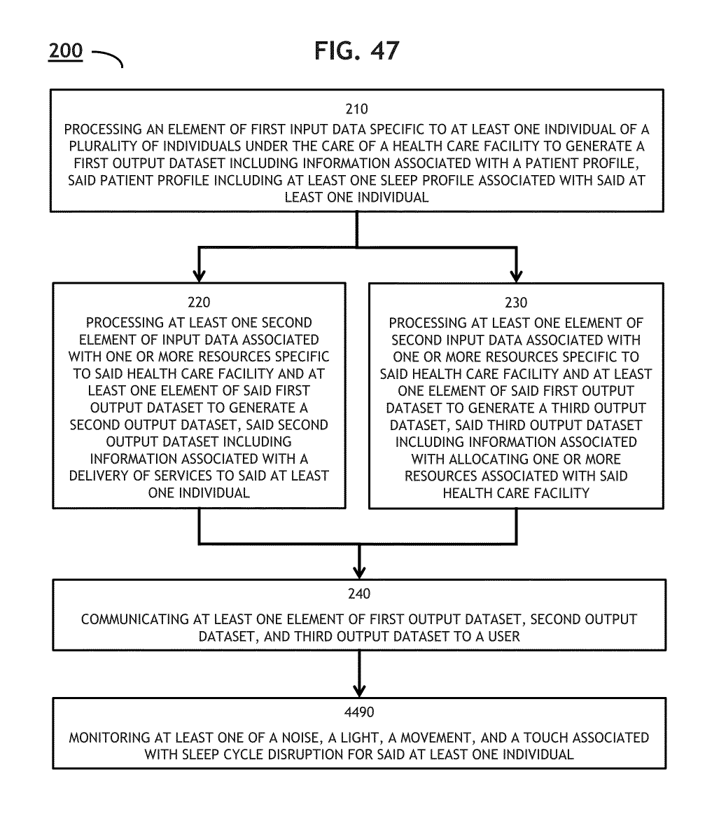

FIG. 47 depicts an alternative embodiment of operational flow 200 as depicted in FIG. 46. In alternative operation 4490, monitoring at least one stress inducer associated with sleep cycle disruption for said at least one individual includes monitoring at least one of a noise, a light, a movement, and a touch associated with sleep cycle disruption for said at least one individual.

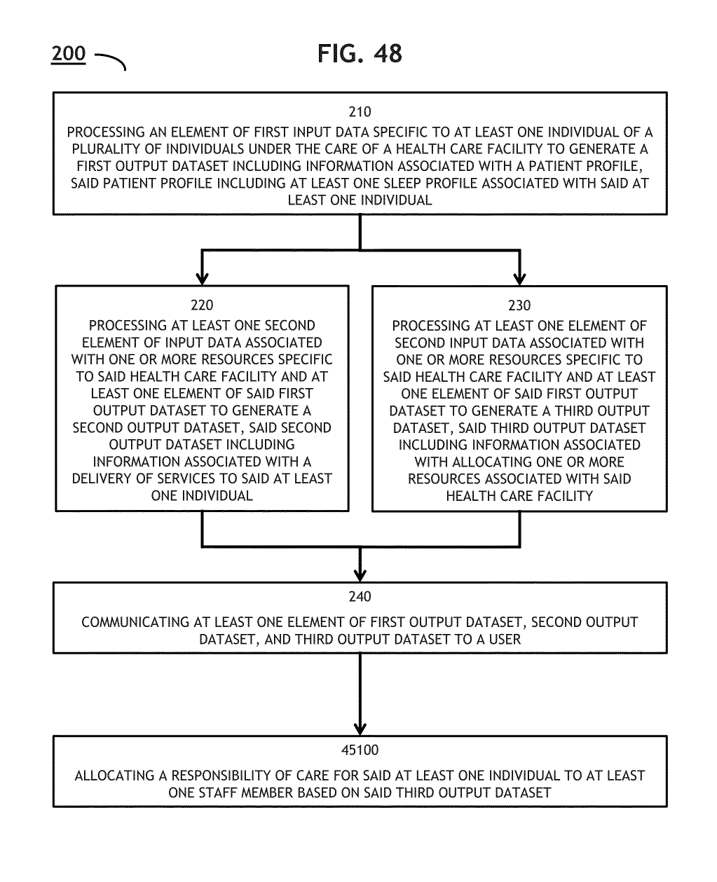

FIG. 48 depicts an alternative embodiment of operational flow 200 as depicted in FIG. 5. Operational flow 200 may have an additional operation 45100, comprising allocating a responsibility of care for said at least one individual to at least one staff member based on said third output dataset 124.

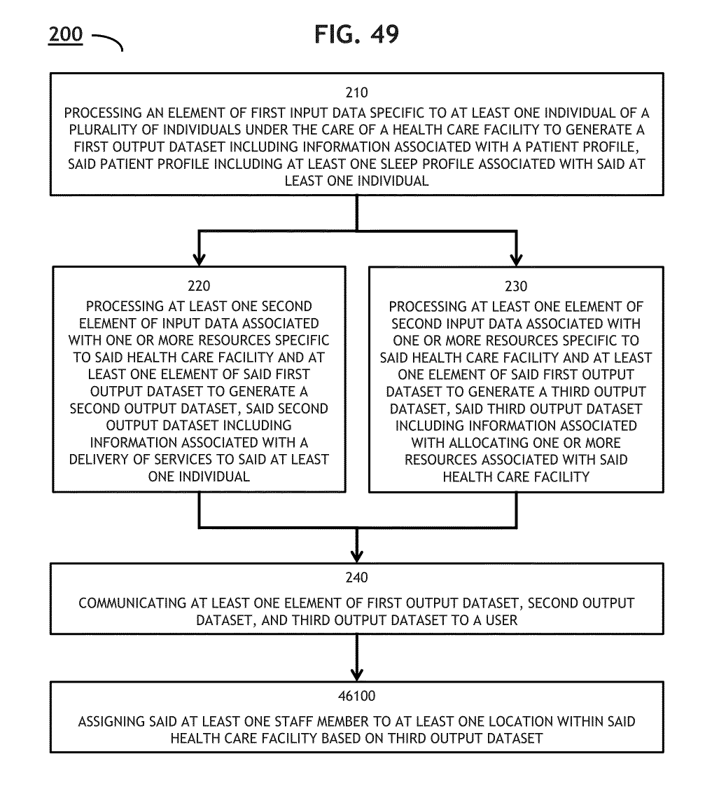

FIG. 49 depicts an alternative embodiment of operational flow 200 as depicted in FIG. 48. In alternative operation 46100, allocating a responsibility of care for said at least one individual to at least one staff member based on third output dataset 124 includes assigning said at least one staff member to at least one location within said health care facility based on said third output dataset 124.

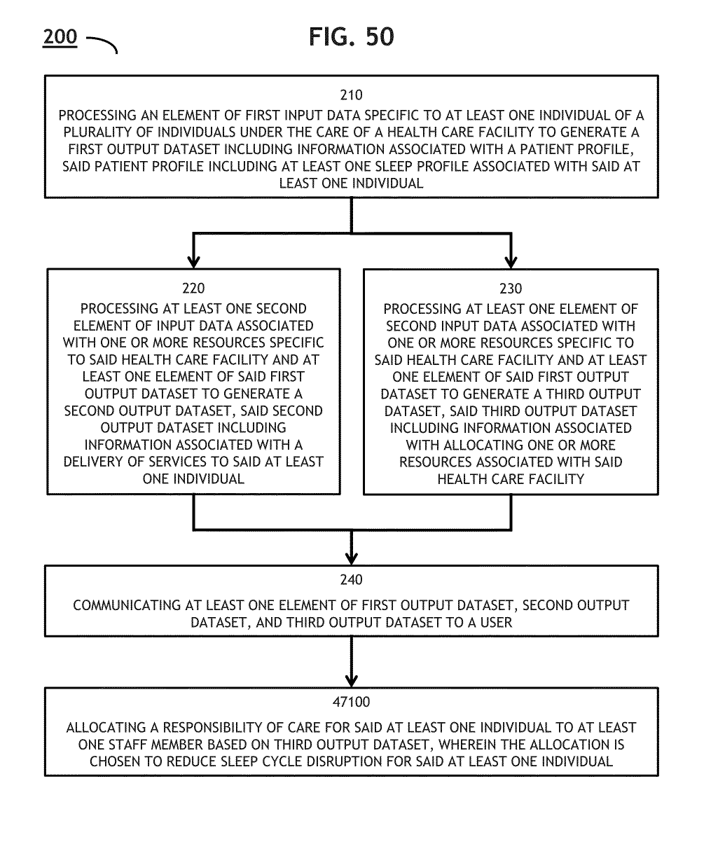

FIG. 50 depicts an alternative embodiment of operational flow 200 as depicted in FIG. 48. In alternative operation 47100, allocating a responsibility of care for said at least one individual to at least one staff member based on third output dataset 124 includes allocating a responsibility of care for said at least one individual to at least one staff member based on third output dataset 124, wherein the allocation is chosen to reduce sleep cycle disruption for said at least one individual.

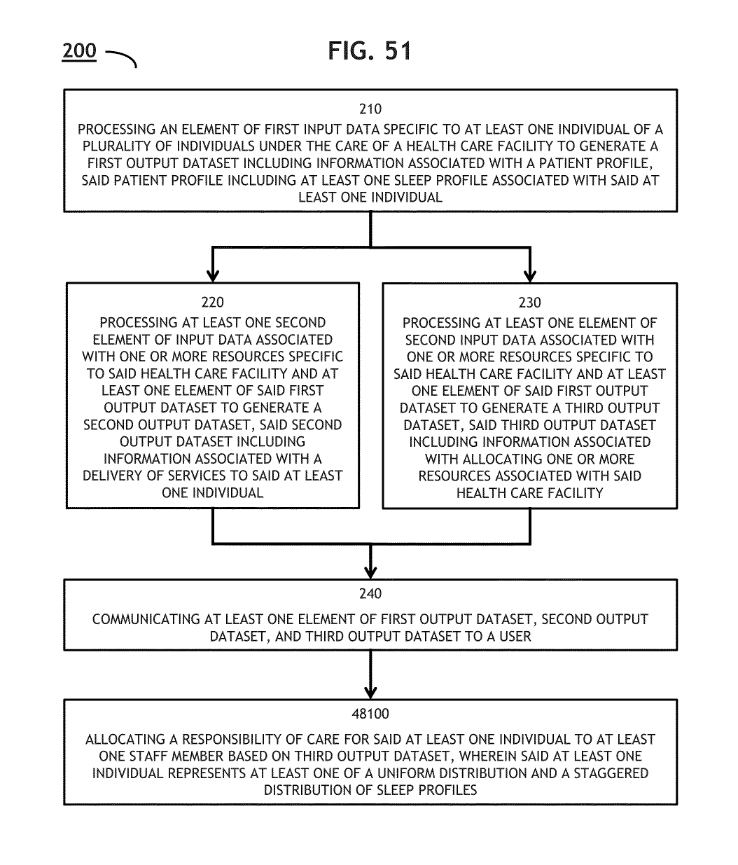

FIG. 51 depicts an alternative embodiment of operational flow 200 as depicted in FIG. 48. In alternative operation 48100, allocating a responsibility of care for said at least one individual to at least one staff member based on third output dataset 124 includes allocating a responsibility of care for said at least one individual to at least one staff member based on third output dataset 124, wherein said at least one individual represents at least one of a uniform distribution and a staggered distribution of sleep profiles.

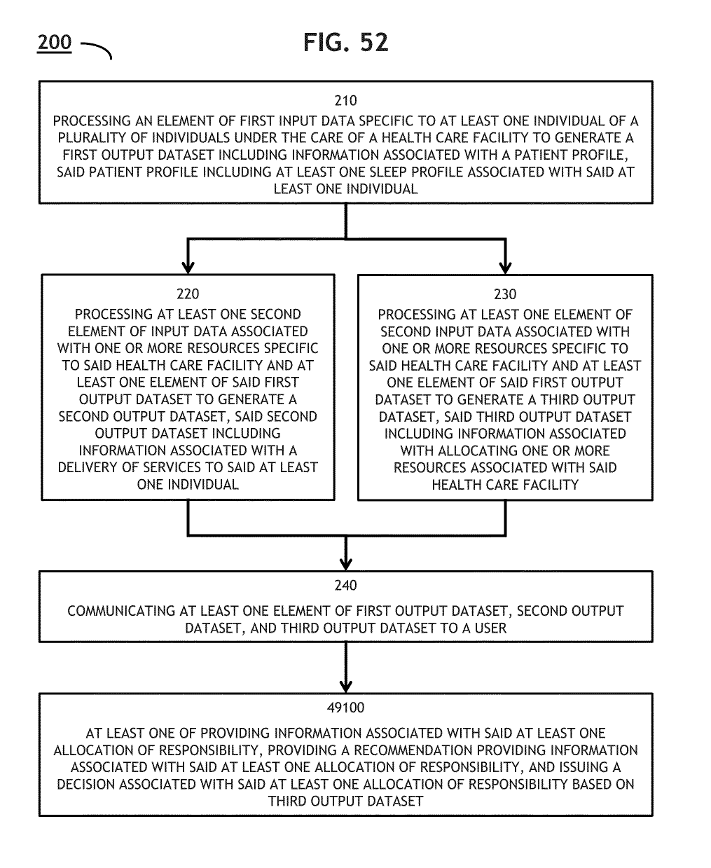

FIG. 52 depicts an alternative embodiment of operational flow 200 as depicted in FIG. 48. In alternative operation 49100, allocating a responsibility of care for said at least one individual to at least one staff member based on third output dataset 124 includes at least one of providing information associated with said at least one allocation of responsibility, providing a recommendation providing information associated with said at least one allocation of responsibility, and issuing a decision associated with said at least one allocation of responsibility.

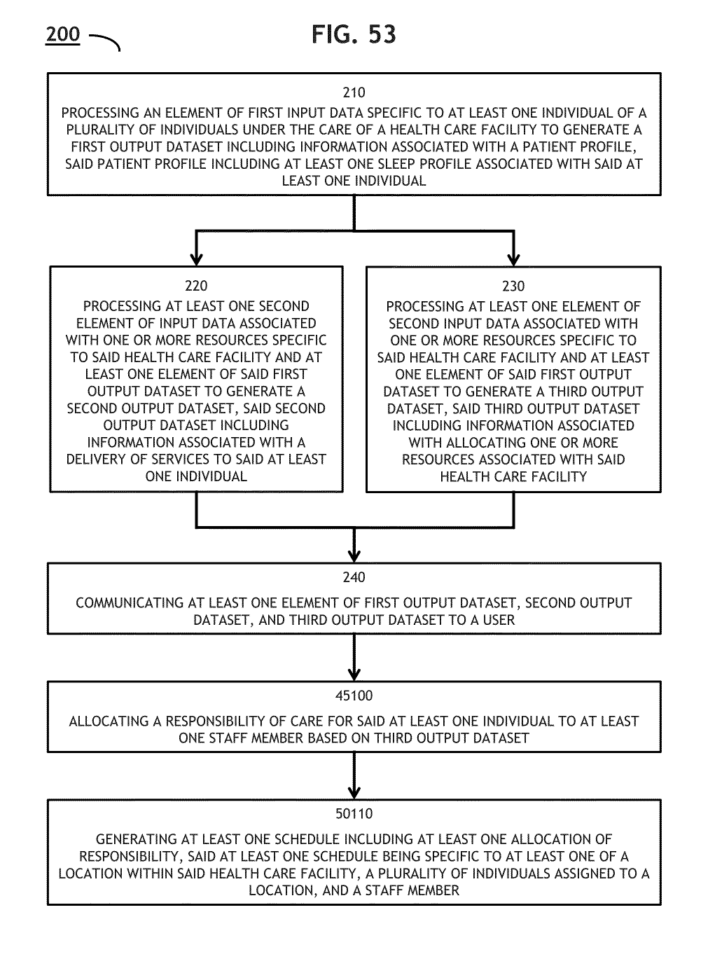

FIG. 53 depicts an alternative embodiment of operational flow 200 as depicted in FIG. 48. Operational flow 200 may have an additional operation 50110, comprising generating at least one schedule including at least one allocation of responsibility, said at least one schedule being specific to at least one of a location within said health care facility, a plurality of individuals assigned to a location, and a staff member.

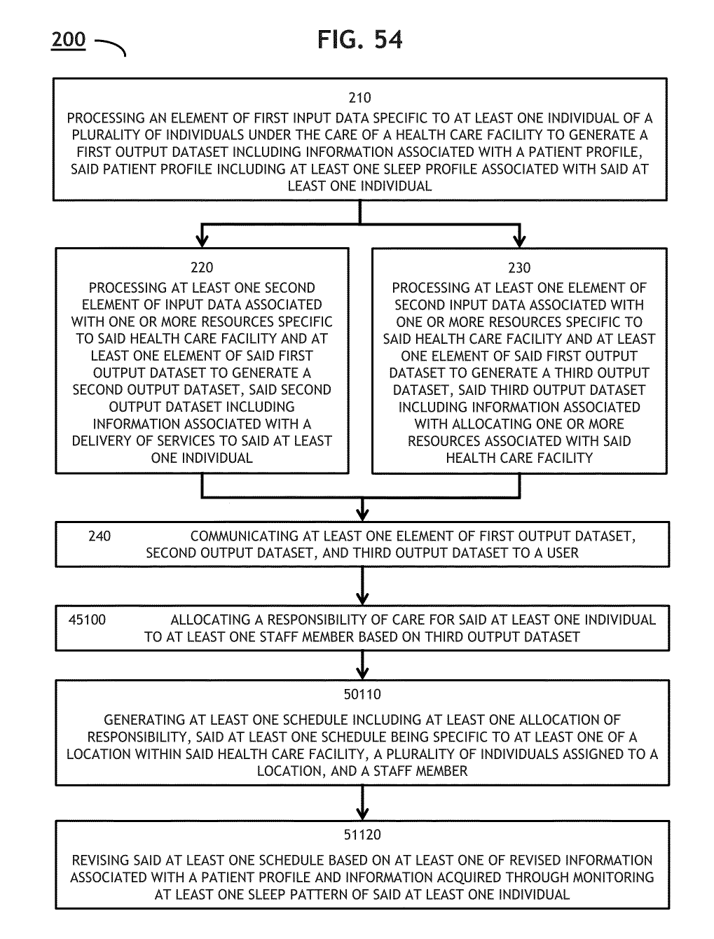

FIG. 54 depicts an alternative embodiment of operational flow 200 as depicted in FIG. 53. Operational flow 200 may have an additional operation 51120, comprising revising said at least one schedule based on at least one of revised information associated with a patient profile 120(a) and information acquired through monitoring at least one sleep pattern of said at least one individual.

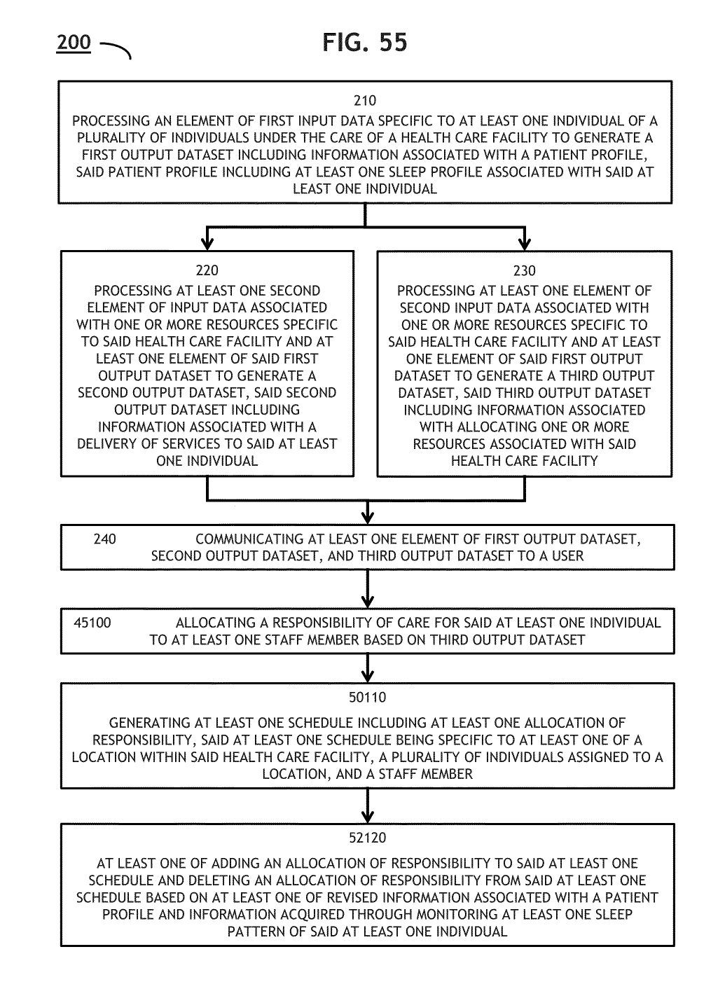

FIG. 55 depicts an alternative embodiment of operational flow 200 as depicted in FIG. 54. In alternative operation 52120, revising said at least one schedule includes at least one of adding an allocation of responsibility to said at least one schedule and deleting an allocation of responsibility from said at least one schedule.

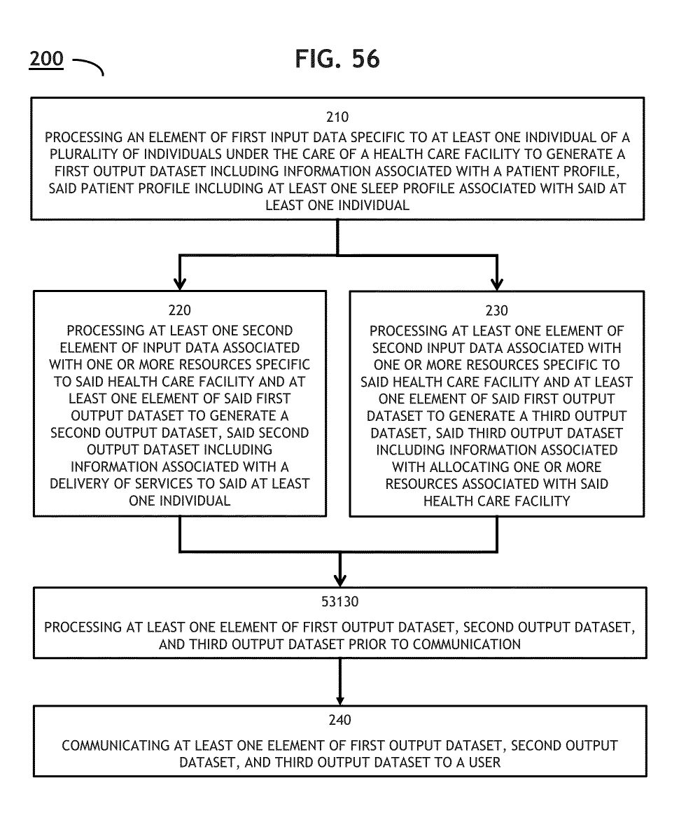

FIG. 56 depicts an alternative embodiment of operational flow 200 as depicted in FIG. 5. Operational flow 200 may have an additional operation 53130, comprising processing at least one element of said first output dataset 120, said second output dataset 122, and said third output dataset 124 prior to communication.

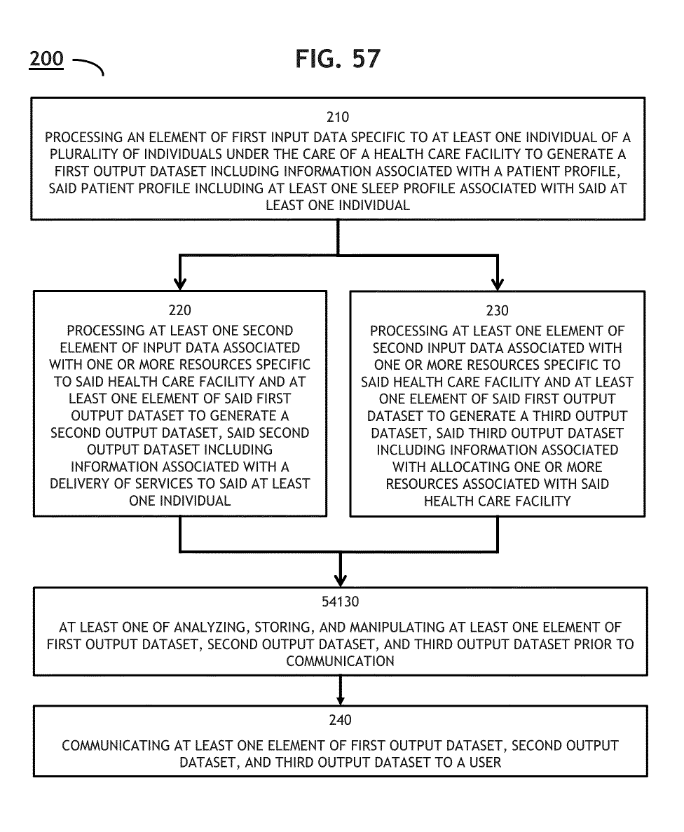

FIG. 57 depicts an alternative embodiment of operational flow 200 as depicted in FIG. 56. In alternative operation 54130, processing at least one element of said first output dataset 120, said second output dataset 122, and said third output dataset 124 prior to communication includes at least one of analyzing said at least one element, storing said at least one element, and manipulating said at least one element.

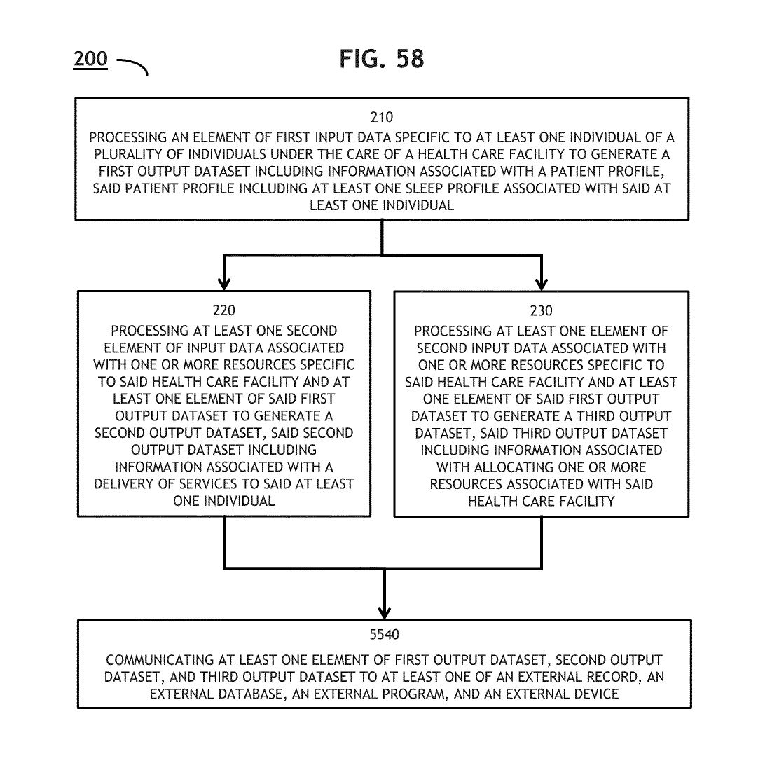

FIG. 58 depicts an alternative embodiment of operational flow 200 as depicted in FIG. 5. In alternative operation 5540, communicating at least one element of first output dataset 120, second output dataset 122, and third output dataset 124 to a user includes communicating at least one element of first output dataset 120, second output dataset 122, and third output dataset 124 to at least one of an external record 150, an external database 152, an external program 154, and an external device 156.

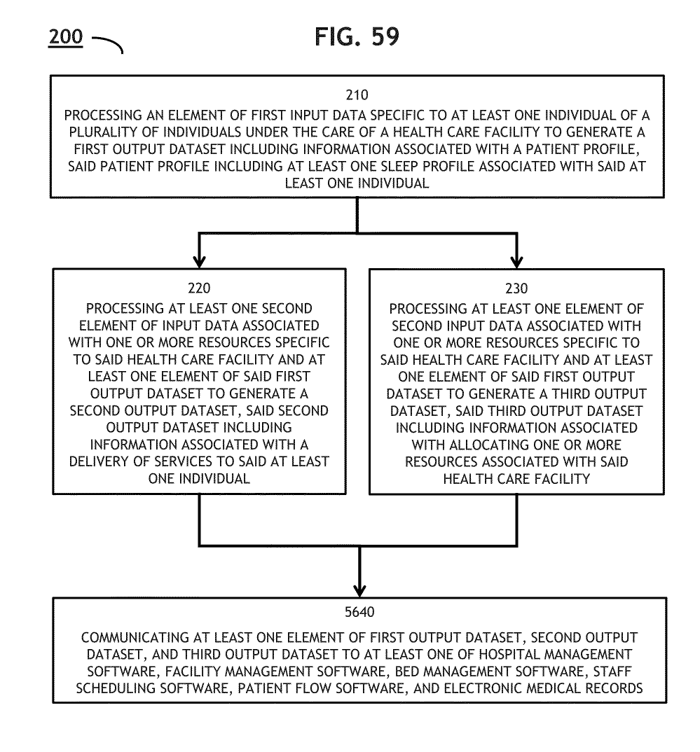

FIG. 59 depicts an alternative embodiment of operational flow 200 as depicted in FIG. 58. In alternative operation 5640, communicating at least one element of first output dataset 120, second output dataset 122, and third output dataset 124 to at least one of an external record 150, an external database 152, an external program 154, and an external device 156 includes communicating at least one element of first output dataset 120, second output dataset 122, and third output dataset 124 to at least one of hospital management software, facility management software, bed management software, staff scheduling software, patient flow software, and electronic medical records.

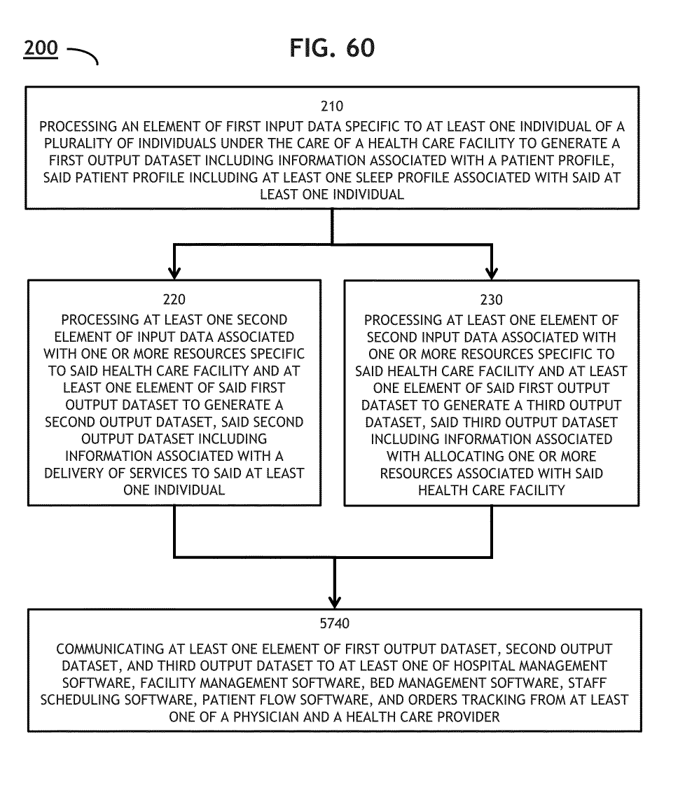

FIG. 60 depicts an alternative embodiment of operational flow 200 as depicted in FIG. 59. In alternative operation 5740, communicating at least one element of first output dataset 120, second output dataset 122, and third output dataset 124 to at least one of hospital management software, facility management software, bed management software, staff scheduling software, patient flow software, and electronic medical records includes communicating at least one element of first output dataset 120, second output dataset 122, and third output dataset 124 to at least one of hospital management software, facility management software, bed management software, staff scheduling software, patient flow software, and orders tracking from at least one of a physician and a health care provider.

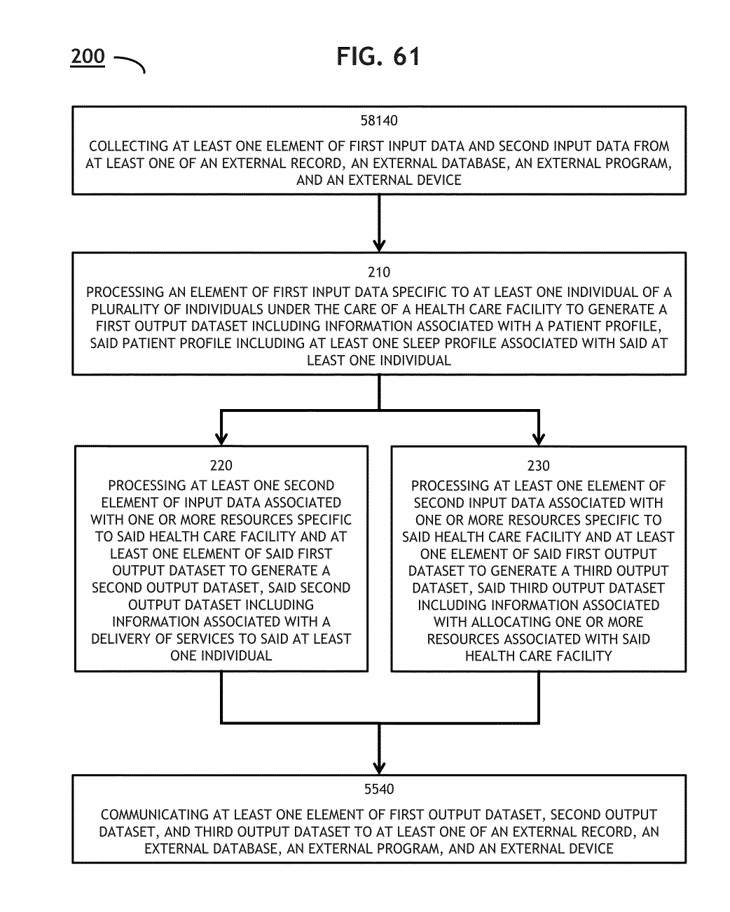

FIG. 61 depicts an alternative embodiment of operational flow 200 as depicted in FIG. 58. Operational flow 200 may have an additional operation 58140, comprising collecting at least one of said element of first input data 102 and said element of second input data 104 from said at least one of an external record 150, an external database 152, an external program 154, and an external device 156.

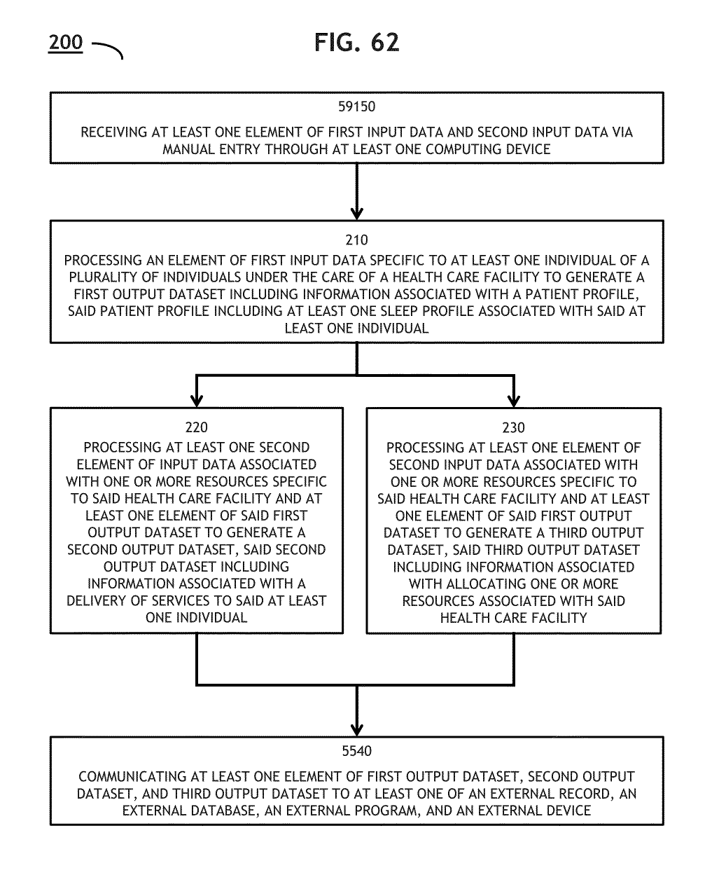

FIG. 62 depicts an alternative embodiment of operational flow 200 as depicted in FIG. 58. Operational flow 200 may have an additional operation 59150, comprising receiving at least one of said element of first input data 102 and said element of second input data 104 via manual entry through at least one computing device 160.

Prophetic Example

In an example of an embodiment of the system described herein a healthcare facility provides healthcare services to a plurality of patients. Each patient is assigned to a room in a ward. Each patient is assigned a care protocol based on the specific medical needs of such patient, and the care protocol information is provided to the system as an element of a first input dataset for such patient. For a specific individual patient, the patient's sleep profile is provided to the system as an element of the first input dataset. The information associated with patient's sleep profile, sleep habits and sleep cycle can be obtained from a questionnaire, medical record data or from a sensor such as a polysomnographic array.

First input dataset includes information indicating that Patients A, D and K have a chronotype of an extreme morning type; patients C, E, H, L, and M have a chronotype of an intermediate type; and patients B, F, G, J, and N have a chronotype of an extreme evening type. To determine logistical and efficient use of resources for providing healthcare services to the patients, a healthcare facility personnel may, prior to a morning shift, query the system to determine the best way to organize patients that have similar sleep histories. Based on the chronotype information, the system will automatically provide a recommendation that patients A, D and K be kept either in adjacent rooms, the same room or same ward. The system will automatically provide a recommendation that patients C, E, H, L and M be kept either in adjacent rooms, the same rooms or same ward. The system will automatically provide a recommendation that patients B, F, G, J, N, O, P, Q and R be assigned to either in adjacent rooms, the same rooms or same ward.

Further, the system can generate an allocation of resource responsibility based on the recommended room or ward assignments of the patient chronotypes. The system can automatically generate a schedule of personnel work shifts to provide the care protocol for each patient. For example, the schedule can include that healthcare facility employee 1 be assigned to the early morning shift to handle the three patients A, D and K. The schedule can indicate that employees 2 and 3 be assigned to handle midday care protocols associated with patients C, E, H, L and M. The schedule can indicate that employees 4, 5 and 6 be assigned to handle evening care protocols associated with patients B, F, G, J, N, O, P, Q and R. Such a schedule can indicate the type of care needed for each patient. The schedule permits the employees to provide a more efficient use of their time providing care for patients of similar chronotypes in a localized area of the facility. Since only three patients require medication in the early morning hours, only one employee (#1) is required to perform the task, and can administer the medication to the patients without disrupting their sleep. The system saves the healthcare money and time by automatically assigning patients, employees and scheduling services.

In addition, the schedule indicates that patient L is due for a complex surgery that requires specifically skilled nurses and physicians. The system has an input that that employee 3 possess the skill and expertise needed for such surgery, and the system automatically schedules the surgery and equipment according to the resources available at the healthcare facility and assigns employee 3 to the shift and to the surgery for patient L.

Those skilled in the art will appreciate that the foregoing specific exemplary system, processes or devices or technologies are representative of more general system, processes or devices or technologies taught elsewhere herein, such as in the claims filed herewith or elsewhere in the present document.

The claims, description, and drawings herein may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to a human reader. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in detail herein, these logical operations/functions are not representations of abstract ideas, but rather are representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats-tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en [dot] wikipedia [dot] org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en [dot] wikipedia [dot] org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct” (e.g., that “software”—a computer program or computer programming—is somehow an ineffable mental construct, because at a high level of abstraction, it can be conceived and understood by a human reader). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of logic, such as Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en [dot] wikipedia [dot] org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en [dot] wikipedia [dot] org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configurations, such machine language instructions also select out and activate specific groupings of logic gates from the millions of logic gates of the more general machine. Thus, far from abstract mathematical expressions, machine language instruction programs, even though written as a string of zeroes and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en [dot] wikipedia [dot] org/wiki/Instructions_per_second (as of Jun. 5, 2012, 21:04 GMT). Thus, programs written in machine language—which may be tens of millions of machine language instructions long—are incomprehensible to most humans. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that useful, tangible, and concrete work is done. For example, as indicated above, such machine language—the compiled version of the higher-level language—functions as a technical specification which selects out hardware logic gates, specifies voltage levels, voltage transition timings, etc., such that the useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality of logic(s), or (d) virtually any combination of the foregoing. Indeed, any physical object which has a stable, measurable, and changeable state may be used to construct a machine based on the above technical description. Charles Babbage, for example, constructed the first mechanized computational apparatus out of wood, with the apparatus powered by cranking a handle.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software, or firmware implementations of aspects of systems; the use of hardware, software, or firmware is generally (but not always, in that in certain contexts the choice between hardware and software can become significant) a design choice representing cost vs. efficiency tradeoffs. Those having skill in the art will appreciate that there are various vehicles by which processes or systems or other technologies described herein can be effected (e.g., hardware, software, or firmware), and that the preferred vehicle will vary with the context in which the processes or systems or other technologies are deployed. For example, if an implementer determines that speed and accuracy are paramount, the implementer may opt for a mainly hardware or firmware vehicle; alternatively, if flexibility is paramount, the implementer may opt for a mainly software implementation; or, yet again alternatively, the implementer may opt for some combination of hardware, software, or firmware in one or more machines, compositions of matter, and articles of manufacture. Hence, there are several possible vehicles by which the processes or devices or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include computer programs or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, or general-purpose components executing or otherwise invoking special-purpose components.

Specifications or other implementations may be transmitted by one or more instances of tangible transmission media as described herein, optionally by packet transmission or otherwise by passing through distributed media at various times. Alternatively or additionally, implementations may include executing a special-purpose instruction sequence or invoking circuitry for enabling, triggering, coordinating, requesting, or otherwise causing one or more occurrences of virtually any functional operation described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, or other such similar mode(s) of expression). For example, some or all of a logical expression (e.g., computer programming language implementation) may be manifested as a Verilog-type hardware description (e.g., via Hardware Description Language (HDL) or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices or processes via the use of block diagrams, flowcharts, or examples. Insofar as such block diagrams, flowcharts, or examples contain one or more functions or operations, it will be understood by those within the art that each function or operation within such block diagrams, flowcharts, or examples can be implemented, individually or collectively, by a wide range of hardware, software, firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

The term module, as used in the foregoing/following disclosure, may refer to a collection of one or more components that are arranged in a particular manner, or a collection of one or more general-purpose components that may be configured to operate in a particular manner at one or more particular points in time, or also configured to operate in one or more further manners at one or more further times. For example, the same hardware, or same portions of hardware, may be configured/reconfigured in sequential/parallel time(s) as a first type of module (e.g., at a first time), as a second type of module (e.g., at a second time, which may in some instances coincide with, overlap, or follow a first time), or as a third type of module (e.g., at a third time which may, in some instances, coincide with, overlap, or follow a first time or a second time), etc. Reconfigurable or controllable components (e.g., general purpose processors, digital signal processors, field programmable gate arrays, etc.) are capable of being configured as a first module that has a first purpose, then a second module that has a second purpose and then, a third module that has a third purpose, and so on. The transition of a reconfigurable or controllable component may occur in as little as a few nanoseconds, or may occur over a period of minutes, hours, or days.

In some such examples, at the time the component is configured to carry out the second purpose, the component may no longer be capable of carrying out that first purpose until it is reconfigured. A component may switch between configurations as different modules in as little as a few nanoseconds. A component may reconfigure on-the-fly, e.g., the reconfiguration of a component from a first module into a second module may occur just as the second module is needed. A component may reconfigure in stages, e.g., portions of a first module that are no longer needed may reconfigure into the second module even before the first module has finished its operation. Such reconfigurations may occur automatically, or may occur through prompting by an external source, whether that source is another component, an instruction, a signal, a condition, an external stimulus, or similar.

For example, a central processing unit of a personal computer may, at various times, operate as a module for displaying graphics on a screen, a module for writing data to a storage medium, a module for receiving user input, and a module for multiplying two large prime numbers, by configuring its logical gates in accordance with its instructions. Such reconfiguration may be invisible to the naked eye, and in some embodiments may include activation, deactivation, or re-routing of various portions of the component, e.g., switches, logic gates, inputs, or outputs. Thus, in the examples found in the foregoing/following disclosure, if an example includes or recites multiple modules, the example includes the possibility that the same hardware may implement more than one of the recited modules, either contemporaneously or at discrete times or timings. The implementation of multiple modules, whether using more components, fewer components, or the same number of components as the number of modules, is merely an implementation choice and does not generally affect the operation of the modules themselves. Accordingly, it should be understood that any recitation of multiple discrete modules in this disclosure includes implementations of those modules as any number of underlying components, including, but not limited to, a single component that reconfigures itself over time to carry out the functions of multiple modules, or multiple components that similarly reconfigure, or special purpose reconfigurable components.

In a general sense, those skilled in the art will recognize that the various embodiments described herein can be implemented, individually or collectively, by various types of electro-mechanical systems having a wide range of electrical components such as hardware, software, firmware, or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, or virtually any combination thereof. Consequently, as used herein “circuitry” includes at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes or devices described herein, or a microprocessor configured by a computer program which at least partially carries out processes or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes or devices described herein, or a microprocessor configured by a computer program which at least partially carries out processes or devices described herein), electrical circuitry forming a memory device (e.g., forms of memory (e.g., random access, flash, read only, etc.)), or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the systems, devices or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position or velocity; control motors for moving/distorting lenses to give desired focuses). An image processing system may be implemented utilizing suitable commercially available components, such as those typically found in digital still systems or digital motion systems.

Those skilled in the art will recognize that at least a portion of the system, devices or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), or control systems including feedback loops and control motors (e.g., feedback for sensing position or velocity; control motors for moving or adjusting components or quantities). A data processing system may be implemented utilizing suitable commercially available components, such as those typically found in data computing/communication or network computing/communication systems.

Those skilled in the art will recognize that at least a portion of the system, devices or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position or velocity; control motors for moving or adjusting components or quantities). A mote system may be implemented utilizing suitable components, such as those found in mote computing/communication systems. Specific examples of such components entail such as Intel Corporation's or Crossbow Corporation's mote components and supporting hardware, software, or firmware.

Those skilled in the art will recognize that it is common within the art to implement devices or processes or systems, and thereafter use engineering or other practices to integrate such implemented devices or processes or systems into more comprehensive devices or processes or systems. That is, at least a portion of the devices or processes or systems described herein can be integrated into other devices or processes or systems via a reasonable amount of experimentation. Those having skill in the art will recognize that examples of such other devices or processes or systems might include—as appropriate to context and application—all or part of devices or processes or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, Verizon, AT&T, etc.), or (g) a wired/wireless services entity (e.g., Sprint, AT&T, Verizon, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located or used outside the territory. Further, implementation of at least part of a system for performing a method in one territory does not preclude use of the system in another territory.

All of the above U.S. patents, U.S. patent application publications, U.S. patent applications, foreign patents, foreign patent applications and non-patent publications referred to in this specification or listed in any Application Data Sheet, are incorporated herein by reference, to the extent not inconsistent herewith.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for automatically managing service delivery or resource allocation by a health care facility, comprising:
processing at least one element of first input data specific to at least one individual of a plurality of individuals under the care of said health care facility to generate a first output dataset, said first output dataset including information associated with a patient profile, said patient profile including at least one sleep profile associated with said at least one individual;
processing either (i) at least one element of second input data associated with one or more resources specific to said health care facility and at least one element of said first output dataset to generate a second output dataset, said second output dataset including information associated with a delivery of services to said at least one individual; or (ii) at least one element of second input data associated with one or more resources specific to said health care facility and at least one element of said first output dataset to generate a third output dataset, said third output dataset including information associated with allocating one or more resources associated with said health care facility; and
communicating at least one element of at least one of said first output dataset, said second output dataset, and said third output dataset to a user.

2. The method of claim 1, wherein said at least one element of first input data includes at least one element of first input data specific to at least one individual of a plurality of individuals under the care of at least one of a hospital, a nursing facility, and a long-term care facility.

3.-4. (canceled)

5. The method of claim 1, wherein said one or more of a resources allocation include at least one unit of facility equipment or service allocation.

6. The method of claim 1, wherein said one or more of a resources allocation include a facility accommodation.

7. (canceled)

8. The method of claim 1, wherein said at least one element of first input data includes at least one data element associated with at least one of a sleep habit, a sleep cycle, a chronotype, and a circadian cycle for said at least one individual.

9. (canceled)

10. The method of claim 8, wherein said sleep cycle includes at least one of stage 1 non-rapid eye movement (NREM) sleep, stage 2 NREM sleep, stage 3 NREM sleep, stage 4 NREM sleep, and rapid eye movement (REM) sleep.

11. (canceled)

12. The method of claim 1, wherein said at least one element of first input data includes a care protocol for said at least one individual.

13. The method of claim 1, wherein said at least one element of first input data includes at least one element of data acquired by a sensor.

14. The method of claim 13, wherein said sensor includes at least one of a polysomnographic array, an actigraph, a thermometer, a chemical sensor, an electroencephalograph, an electrooculograph, an electrocardiograph, and an electromyelograph.

15.-16. (canceled)

17. The method of claim 1, wherein said at least one element of first input data includes at least one data element associated with timing the administration of a medication.

18. The method of claim 1, wherein said at least one element of first input data includes a patient medical history.

19.-21. (canceled)

22. The method of claim 1, wherein said at least one element of first input data is acquired from at least one of an electronic medical record, a database, and a response to a questionnaire.

23.-25. (canceled)

26. The method of claim 1, wherein said at least one element of second input data includes at least one data element specific to at least one location within said health care facility.

27. The method of claim 26, wherein said at least one location includes at least one bed, room, ward, floor level, and other subdivision within said health care facility.

28.-31. (canceled)

32. The method of claim 26, further comprising:
assigning said at least one individual to said at least one location, based on said second output dataset.

33. The method of claim 1, further comprising:
assigning at least one delivery of services to said at least one individual, based on said second output dataset.

34.-36. (canceled)

37. The method of claim 33, further comprising:
generating at least one schedule comprising at least one delivery of services, said at least one schedule being specific to at least one of a location and a plurality of individuals assigned to a location.

38.-45. (canceled)

46. The method of claim 1, further comprising:
allocating a responsibility of care for said at least one individual to at least one staff member, based on said third output dataset.

47.-50. (canceled)

51. The method of claim 46, further comprising:
generating at least one schedule comprising at least one allocation of responsibility, said at least one schedule being specific to at least one of a location within said health care facility, a plurality of individuals assigned to a location, and a staff member.

52.-55. (canceled)

56. The method of claim 1, wherein said user includes at least one of an external record, an external database, an external program, and an external device.

57.-181. (canceled)
